(19) United States
(12) Patent Application Publication
(10) Pub. No.: US 2026/0027725 A1
(43) Pub. Date: Jan. 29, 2026

(54) Visual tracking method of robot

(71) Applicant: AMICRO SEMICONDUCTOR CO., LTD., Guangdong (CN)

(72) Inventor: Ming LI, Guangdong (CN)

(73) Assignee: AMICRO SEMICONDUCTOR CO., LTD., Guangdong (CN)

(21) Appl. No.: 18/996,458

(22) PCT Filed: May 16, 2023
(86) PCT No.: PCT/CN2023/094403

§ 371 Date: Jan. 17, 2025

(30) Foreign Application Priority Data
Jun. 8, 2022 (CN) 202210638498.9

(51) Int. Cl. B25J 9/16; B25J 19/02; G01C 21/16; G06T 7/223

(52) U.S. Cl. CPC B25J 9/1697; B25J 19/023; G01C 21/16; G06T 7/223

(57) ABSTRACT

Disclosed is a visual tracking method of robot, wherein an execution body of the visual tracking method of the robot is a robot fixedly equipped with a camera and an inertial sensor; the visual tracking method of the robot includes: the robot performing image tracking using a window-based matching mode, and when the robot succeeds in performing tracking using the window-based matching mode, the robot stopping performing image tracking using the window-based matching mode, and then the robot performing image tracking using a projection-based matching model; and then, when the robot fails to perform tracking using the projection-based matching mode, the robot stopping performing image tracking using the projection-based matching mode, and then the robot performing image tracking using the window-based matching mode.

### TECHNICAL FIELD

The present disclosure relates to the technical field of computer vision, and in particular, to a visual tracking method of robot.

### BACKGROUND

Visual-inertial odometry (VIO), also sometimes called visual-inertial system (VINS), is an algorithm which fuses data from a camera and an Inertial Measurement Unit (IMU) sensor to implement SLAM. For a conventional classic VIO solution, an initialization stage thereof starts from a pure vision SFM (Structure from Motion) using feature points, and then by performing loosely coupled alignment between the structure and IMU pre-integrated measurement values, measurement scale, speed, gravitational acceleration direction, and IMU zero bias are restored. SLAM (simultaneous localization and mapping) means that a robot starts to move from an unknown position in an unknown environment, performs self-localization according to position estimation and a map in the movement process, and simultaneously constructs an incremental map on the basis of the self-localization, so as to realize autonomous localization and navigation of the robot.

At present, a point feature-based SLAM algorithm uses feature points having a projection relationship as a basis, and can perform feature tracking, image composition and closed-loop detection in real time, so as to complete the whole process of simultaneous localization and map construction. However, the feature tracking (feature extraction and matching) consumes a large computational load, and reduces the real-time performance of robot localization and navigation.

### SUMMARY

The present disclosure discloses a visual tracking method of robot, and the specific technical solution thereof is as follows:

The visual tracking method of the robot, wherein an execution body of the visual tracking method of the robot is a robot fixedly equipped with a camera and an inertial sensor; the visual tracking method of the robot includes: the robot performs image tracking using a window-based matching mode, and when the robot succeeds in performing tracking using the window-based matching mode, the robot stops performing image tracking using the window-based matching mode, and then the robot performs image tracking using a projection-based matching mode; and then, when the robot fails to perform tracking using the projection-based matching mode, the robot stops performing image tracking using the projection-based matching mode, and then the robot performs image tracking using the window-based matching mode.

### BRIEF DESCRIPTION OF THE DRAWINGS

FIG. 1 is a flowchart of a visual tracking method of robot disclosed according to some embodiments of the present disclosure.

FIG. 2 is a flowchart of a method of a robot performing image tracking using a window-based matching mode disclosed according to some other embodiments of the present disclosure.

### DETAILED DESCRIPTION OF THE EMBODIMENTS

Hereinafter, the technical solutions in embodiments of the present disclosure will be described in detail with reference to the accompanying drawings in the embodiments of the present disclosure. In should be noted that terms “include” and “have” and any variations thereof in the description, claims and drawings of the present disclosure are intended to cover a non-exclusive inclusion, for example, a process, method, system, product or device which includes a series of steps or units is not necessarily limited to those steps or units that are clearly listed, but may include other steps or units that are not clearly listed or are inherent to these process, method, product or device. In should be noted that: similar numerals and letters represent similar items in the following accompanying drawings, and thus once a certain item is defined in one accompanying drawing, it does not need to be further defined and explained in subsequent accompanying drawings. The term “and/or” herein merely describes an association relationship, and indicates that three relationships may exist, for example, “A and/or B” may indicate three cases: A exists individually, both A and B exist, and B exists individually. In addition, the term “at least one” herein means any combination of at least two of any one or more of a plurality of elements, including, for example, “at least one of A, B and C” may mean including any one or more elements selected from a set consisting of A, B, and C.

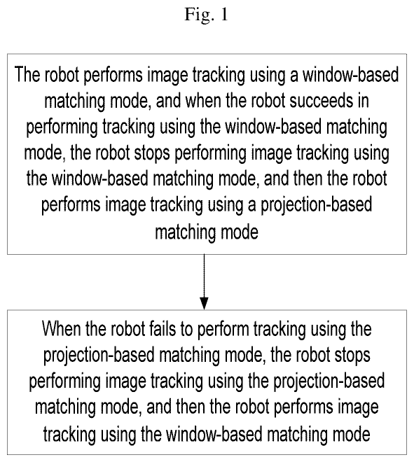

As some embodiments, disclosed is a visual tracking method of robot, wherein an execution body of the visual tracking method of the robot is a robot fixedly equipped with a camera and an inertial sensor; and wherein the robot is an autonomous mobile robot. As shown in FIG. 1, the visual tracking method of the robot includes: the robot performs image tracking using a window-based matching mode, and when the robot succeeds in performing tracking using the window-based matching mode, the robot stops performing image tracking using the window-based matching mode, and then the robot performs image tracking using a projection-based matching mode. In the present embodiment, in the process of the robot performing image tracking using the window-based matching mode, the robot performs matching between all reference frame images in a sliding window and the same current frame image by using the window-based matching mode (specifically involving matching between feature points), so as to track the current frame image by the reference frame images; and when the robot succeeds in tracking the current frame image using the window-based matching mode, the robot has completed matching between all the reference frame images in the sliding window and the same current frame image, and a reference frame image with the best matching degree is acquired from all the reference frame images, and then the robot can stop performing image tracking using the window-based matching mode; and then the robot performs matching between a previous frame image and the current frame image by using the projection-based matching mode, and starts to track the current frame image by the previous frame image.

Then, when the robot fails to perform tracking using the projection-based matching mode, the robot stops performing image tracking using the projection-based matching mode, and then the robot performs image tracking using the window-based matching mode. When the robot fails to perform image tracking using the projection-based matching mode, it is determined that matching between the previous frame image and the current frame image fails, then the robot does not continue to perform image tracking using the projection-based matching mode, and then performs tracking of a newly collected image using the window-based matching mode again. Generally, when the robot fails to perform tracking using the window-based matching mode or fails to perform tracking using the projection-based matching mode, it means that all the previously collected multiple frame images cannot successfully match the current frame image, and therefore the current frame image cannot be tracked, that is, it is understood as losing tracking of the current frame image.

In summary, in the present embodiment, the window-based matching mode and the projection-based matching mode are used in turn for image tracking. Specifically, under different tracking results, image tracking is performed by adopting an adaptive matching mode, so as to adaptively track in stages the current frame image collected by the robot in real time; and images predetermined under different matching modes are used to track, with different feature point search ranges and transformation modes, the current frame image collected in real time, so as to complete efficient and reasonable matching between two adjacent frame images, thereby solving the problems of a low operating frame rate and poor real-time performance of navigation and localization in a robot platform having limited computing capability in a simple feature method-based visual odometer, such that an average tracking time of the current frame image is greatly reduced, the operating frame rate of the visual odometer composed of the camera and the inertial sensor is improved, and real-time localization of the robot is well achieved.

As some embodiments, the visual tracking method of the robot further includes: when the robot fails to perform tracking using the window-based matching mode, the robot stops performing image tracking using the window-based matching mode, and the robot clears the sliding window, including clearing all frame images within the sliding window, so as to allow for filling in of newly collected images; and then the robot performs image tracking using the window-based matching mode, and performs image tracking on the basis of updated reference frame images, so as to establish a matching relationship between the new reference frames and the current frame image; and after the robot succeeds in performing tracking using the window-based matching mode, the current frame image is filled in the sliding window, so as to facilitate tracking of an image collected by the robot in real time, and then the current frame image will be updated with a next frame image collected by the camera, such that the robot may match the current frame image newly filled in the sliding window with the next frame image, so as to track the next frame image. In this way, the interference of erroneously-matched image frames is eliminated, and the real-time performance and accuracy of tracking are ensured by introducing newly collected image frames.

In addition, in the process of the robot performing image tracking using the projection-based matching mode, if it is detected that a time interval between the current frame image and a previous frame image exceeds a preset time threshold, the robot stops performing image tracking using the projection-based matching mode, and instead, performs image tracking using the window-based matching mode; in some embodiments, the preset time threshold is set as 1 second, and the detection manner herein is timing detection. When a time interval between two adjacent frame images continuously collected by the robot exceeds 1 second, then the robot stops performing image tracking using the projection-based matching mode, and instead, performs image tracking using the window-based matching mode, as an excessive collection time interval will cause accumulation of a great pose error for projection transformation between two adjacent frame images.

It should be noted that, the image tracking is used to indicate matching between feature points of a previously collected image and feature points of the current frame image; and in the process in which the robot performs image tracking using the window-based matching mode, the robot fills at least one previously collected frame image into the sliding window, such that feature points of the image in the sliding window can match the feature points of the current frame image. The number of frames of all images filled in the sliding window required by the window-based matching mode, i.e. the size of the sliding window, is a fixed numerical value; and all images filled in the sliding window are marked as reference frame images, and are taken as a group of candidate matching key frames. Each of the reference frame images mentioned in the present embodiment may be referred to as a reference frame for short, the current frame image may be referred to as a current frame for short, one frame of image may be referred to as one image frame for short, and two adjacent frames of images may be referred to as two adjacent frames or two adjacent image frames for short. The feature points are pixel points belonging to the image, and the feature points are environmental elements existing in the form of points in an environment where the camera is located.

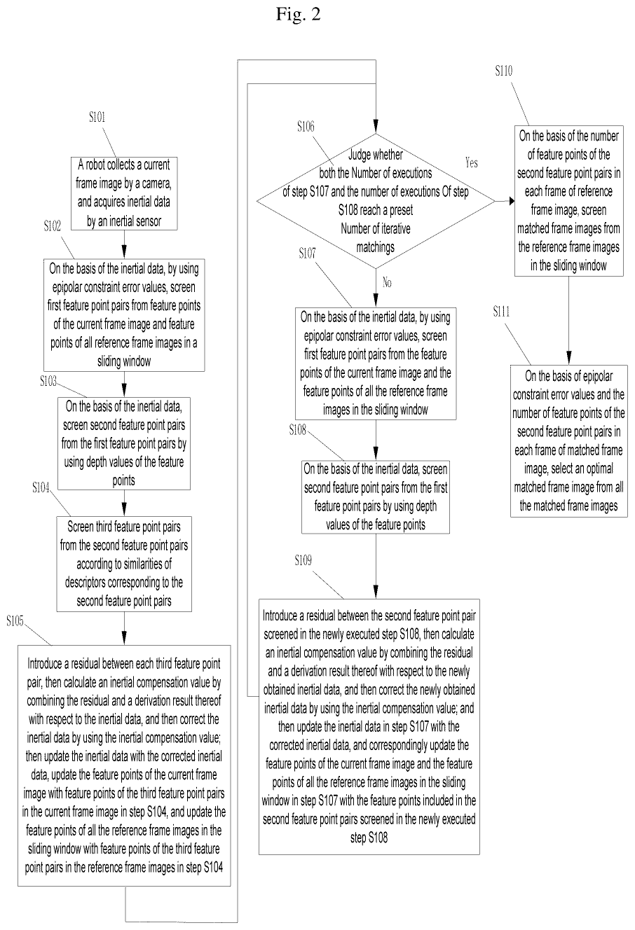

As some embodiments, as shown in FIG. 2, the method in which the robot performs image tracking using the window-based matching mode includes the following steps:

step S101, the robot collects a current frame image by the camera, and acquires inertial data by the inertial sensor; and then, the robot executes step S102. The camera is equipped on the outer side of the robot, and a lens of the camera faces towards an advancing direction of the robot, and is used for collecting image information in front of the robot, and if counted by frame, the camera collects the current frame image, and the robot acquires feature points from the current frame image; wherein the feature points refer to environmental elements existing in the form of points in an environment where the camera device is located, so as to facilitate matching with a previously collected image, thereby realizing tracking of the current frame image. The inertial sensor is generally mounted inside a machine body of the robot, for example, an encoder disc is mounted in a drive wheel of the robot, and is used for acquiring displacement information generated during motion of the robot; and an inertial measurement unit (such as a gyroscope) is used for acquiring angle information generated during motion of the robot; wherein the encoder disc and the inertial measurement unit constitute an inertial system, which is used for acquiring the inertial data, so as to determine a pose transformation relationship of the camera between any two frame images; the robot can use the pose transformation relationship to perform matching transformation between feature points; wherein an initial state quantity of a rotation matrix and an initial state quantity of a translation vector involved in the pose transformation relationship of the camera between the two frame images are preset. On the basis of these initial state quantities, the robot performs integration processing depending on a displacement variation quantity sensed by the encoder disc between two frame images successively collected by the camera and an angle variation quantity sensed by the gyroscope between the two frame images successively collected by the camera, wherein the integration processing may be respectively performed on the displacement variation quantity and the angle variation quantity by using Euler integration, so as to obtain a pose variation quantity of the robot between any two frame images (including frame images from a plurality of pre-collected frame images), and then the latest rotation matrix and the latest translation vector may be obtained. Therefore, the inertial data disclosed in the present embodiment can represent a transformation relationship between a coordinate system of the current frame image and a coordinate system of a reference frame image, including a translation transformation relationship, a rotation transformation relationship, a displacement difference value, an angle increment, etc.; wherein the reference frame image is an image in the sliding window with a fixed size as disclosed in the foregoing embodiment.

Step S102, on the basis of the inertial data, the robot uses epipolar constraint error values to screen first feature point pairs from feature points of the current frame image and feature points of all reference frame images in the sliding window, so as to filter out feature point pairs with too large epipolar constraint error values, thereby filtering out unmatched feature points between the current frame image and each frame of reference frame image; and then, step S103 is executed. In the present embodiment, on the basis of the transformation relationship between the coordinate system of the current frame image and the coordinate system of the reference frame image involved in the inertial data, the robot performs epipolar constraint on the feature points of the current frame image and the feature points of all the reference frame images in the sliding window, to obtain an epipolar constraint error value of each feature point pair; wherein the epipolar constraint error value is an error value calculated for a feature point of the current frame image and a feature point of the reference frame image in the sliding window according to a geometric imaging relationship under epipolar constraint; and the epipolar constraint is used to represent a geometric relationship of pixel points corresponding to one three-dimensional point in a space on different imaging planes, and also represents a projective relationship (or the geometric relationship of various matching points) of pixels in two frame images successively collected by the camera which moves along with the robot. Feature points of the first feature point pairs may be located in the current frame image and each frame of reference frame image respectively, and may also be located in the current frame image and some frames of reference frame images respectively; the sliding window is configured to fill in at least one pre-collected frame image; so as to subsequently implement matching between the current frame and each frame in the sliding window; and the feature points are pixel points in the images, and the feature points are environmental elements existing in the form of points in an environment where the camera is located, and are used for describing environmental features requiring to be tracked by the robot.

Step S103, on the basis of the inertial data, the robot screens second feature point pairs from the first feature point pairs by using depth values of the feature points; and then, step S104 is executed. in step S103, on the basis of each of the first feature point pairs filtered in step S102, within the range of noise effect of pixel points, the robot calculates depth information of a feature point of the first feature point pair in the current frame image, and depth information of a feature point of the first feature point pair in the reference frame image. Specifically, the depth values of corresponding feature points are calculated by using displacement information of the robot (or camera) between the current frame image and the reference frame image, and normalized plane coordinates of the feature points of the first feature point pair, which are involved in the inertial data. In some embodiments, a feature point of a first feature point pair in the current frame image is marked as P1, an optical center when the camera collects the current frame image is marked as O1, a feature point of the first feature point pair in the reference frame image is marked as P2, and an optical center when the camera collects the reference frame image is marked as O2; then without considering noise effect of pixel points, a straight line O1P1 and a straight line O2P2 intersect at a point P3, and the length of a line segment O1P3 is a depth value of the feature point P1, and the length of a line segment O2P3 is a depth value of the feature point P2. Then, when it is judged that the ratio of the depth value of the feature point P1 to the depth value of the feature point P2 satisfies a certain ratio range, the feature point P1 and the feature point P2 form a second feature point pair; otherwise, the feature point P1 and the feature point P2 form an erroneously-matched point pair, thereby screening a second feature point pair from the first feature point pairs.

Step S104, third feature point pairs are screened from the second feature point pairs according to similarities of descriptors corresponding to the second feature point pairs; and then, step S105 is executed. Step S104 specifically includes: for the current frame image and each frame of reference frame image in the sliding window, the robot calculates a similarity between a descriptor of a feature point of each second feature point pair in the reference frame image and a descriptor of a feature point of the second feature point pair in the current frame image; and when a similarity between a descriptor of a feature point of the second feature point pair in a reference frame image and a descriptor of a feature point of the second feature point pair in the current frame image calculated by the robot is the minimum value among similarities between descriptors of the current frame image and descriptors of the reference frame image where the feature point of the second feature point pair is located, the second feature point pair is marked as a third feature point pair and it is determined that a third feature point pair has been screened, thereby narrowing the search range of the feature points. The descriptors of the reference frame image where the feature point of the second feature point pair is located are descriptors of all feature points forming second feature point pairs in the reference frame image where the feature point of the second feature point pair is located, and may be represented using frame descriptors. The descriptors of the current frame image are descriptors of feature points in the current frame image which form second feature point pairs with the feature points in the reference frame image where the feature point of the second feature point pair is located; and the similarity between descriptors corresponding to each second feature point pair is represented by a Euclidean distance or a Hamming distance between a descriptor of a feature point in the current frame image and a descriptor of a feature point in a corresponding reference frame image in the sliding window. In this way, the current frame image is tracked by using the similarity of pixel points between two frames, so as to track the motion of the robot.

Specifically, in step S104, the robot marks a reference frame image where a feature point of each second feature point pair is located as a reference frame image to be matched, and generally, the number of reference frame images to be matched is equal to the number of reference frame images; and the robot also marks second feature point pairs existing between the current frame image and each reference frame image to be matched as second feature point pairs to be matched; wherein a feature point of each second feature point pair to be matched in the current frame image is marked as a second-first feature point, and a feature point of the second feature point pair to be matched in the reference frame image is marked as a second-second feature point, such that the second-second feature point is located in the reference frame image to be matched; and the robot needs to calculate the similarities between descriptors of all second-second feature points in the reference frame image and descriptors of second-first feature points corresponding thereto. Then, when the similarity between a descriptor of a feature point of the second feature point pair to be matched in a reference frame image and a descriptor of a feature point of the second feature point pair to be matched in the current frame image calculated by the robot is the smallest value among similarities between descriptors of all second-second feature points in the reference frame image and descriptors of second-first feature points corresponding thereto, the second feature point pair to be matched is marked as a third feature point pair, and it is determined that a third feature point pair has been screened; wherein multiple third feature point pairs may be screened between each frame of reference frame image and the current frame image. The similarity between a descriptor of a feature point of the second feature point pair to be matched in a reference frame image and a descriptor of a feature point of the second feature point pair to be matched in the current frame image is similarity between a descriptor of a second-second feature point and a descriptor of a second-first feature point, and is taken as a similarity metric between two descriptors, and is specifically expressed as the square root of sum of squares of Euclidean distances or Hamming distances between the second-second feature point and the second-first feature point in a plurality of dimensions; wherein each dimension may represent a binary encoding form of the feature points.

On the basis of the embodiments above, each time after the robot finishes searching all feature points forming second feature point pairs between the current frame image and one frame of reference frame image in the sliding window, that is, after the robot calculates, in one frame of reference frame image, the similarities between descriptors of all second-first feature points and descriptors of corresponding second-first feature points, if the robot calculates that the number of third feature point pairs in the frame of reference frame image is greater than a first preset point number threshold, it is determined that the current frame image successfully matches the frame of reference frame image; and then the robot continues to search all feature points forming second feature point pairs between the current frame image and a next frame of reference frame image in the sliding window; and if the robot calculates that the number of third feature point pairs in the frame of reference frame image is smaller than or equal to the first preset point number threshold, it is determined that matching between the current frame image and the frame of reference frame image fails, and the frame of reference frame image is set as an erroneously-matched reference frame image; and then the robot continues to search all feature points forming second feature point pairs between the current frame image and a next frame of reference frame image in the sliding window. In some embodiments, subsequently, feature points of the frame of reference frame image will not be used for matching with the feature points of the current frame image, and in some embodiments, the first preset point number threshold is set as 20. In some embodiments, feature points of the frame of reference frame image are marked as erroneously-matched feature points, and will no longer form the first feature point pairs, the second feature point pairs, or the third feature point pairs together with the feature points in the current frame image; if the robot calculates that the number of third feature point pairs in the frame of reference frame image is greater than the first preset point number threshold, it is determined that the current frame image successfully matches the frame of reference frame image; wherein when the robot determines that all matchings between the current frame image and all frames of reference frame images in the sliding window fail, it is determined that tracking by the robot using the window-based matching mode fails, and then the robot clears the images in the sliding window.

Step S105, the robot introduces a residual between each third feature point pair, then calculates an inertial compensation value by combining the residual and a derivation result thereof with respect to the inertial data, and then corrects the inertial data by using the inertial compensation value. In some embodiments, a feature point of a third feature point pair in a current frame image e1 is marked as a point P4, an optical center when the camera collects the current frame image e1 is marked as a point O1, a feature point of the third feature point pair in a reference frame image e2 is marked as a point P5, and an optical center when the camera collects the reference frame image e2 is marked as a point O2, then a straight line O1P4 intersects with a straight line O2P5 at a point P6, the point O1, the point O2 and the point P6 form an epipolar plane, and a straight line O1P4 is transformed to the reference frame image e2 and then becomes an epipolar line L. Without considering an error, an intersection line between the epipolar plane and the reference frame image e2 coincides with the epipolar line L, and the intersection line passes through the point P5, but actually they do not overlap with each other due to the existence of error; and in the present embodiment, the point P5 is set as one observation point on the epipolar line L; and then the distance between the point P5 and the epipolar line L is used to represent the error, and then the error is set as the residual.

Further, in the present embodiment, acquiring the residual needs to construct a derivation formula equivalent to calculating a point-to-line distance, and when a corresponding rotation matrix and translation vector are first set to have known state quantities, a residual value may be calculated by using the derivation formula and is taken as a numerical value result of the residual; then the corresponding rotation matrix and translation vector are set to have unknown state quantities, and then the derivation formula (equivalent to an equation) is controlled to respectively take partial derivatives of the translation vector and the rotation matrix, so as to obtain a Jacobian matrix, thereby realizing derivation of the residual to a pose, such that the derivation result about the inertial data is stored in the form of a matrix. Then, in consideration of the properties of derivatives, it can be determined that the robot sets the product between an inverse matrix of the Jacobian matrix and the residual value as the inertial compensation value, and acquires a compensation quantity for a displacement integral quantity and a compensation quantity for an angle integral quantity as the inertial compensation value, so as to solve the derivation formula corresponding to the residual by using a least squares method to obtain the inertial compensation value; and then the robot corrects the inertial data by using the optimal compensation value, and the specific correction manner includes, but is not limited to, addition, subtraction, multiplication or division with the original inertial data. Then, the robot updates the inertial data with the corrected inertial data, updates the feature points of the current frame image with feature points of the third feature point pairs in the current frame image in step S104, and updates the feature points of all the reference frame images in the sliding window with feature points of the third feature point pairs in the reference frame images in step S104, thereby narrowing the subsequent search range of the feature points, completing filtering of the feature points once, and also completing one initialization of the feature points of the current frame image and each frame of reference frame image in the sliding window; and then, step S106 is executed.

Step S106, it is judged whether both the number of executions of step S107 and the number of executions of step S108 reach a preset number of iterative matchings, and if so, step S110 is executed; otherwise, step S107 is executed. In some embodiments, step S106 may also be understood as judging whether the number of executions of step S107, the number of executions of step S108, and the number of executions of step S109 all reach the preset number of the iterative matchings; if so, step S110 is executed; otherwise, step S107 is executed, such that the number of corrections of the inertial data reaches a sum value of the preset number of the iterative matchings and numerical value 1. In some embodiments, the preset number of the iterative matchings is 2 or 3. The robot screens the second feature point pairs by repeatedly executing step S107 and step S108, and eliminates more erroneously-matched point pairs, thereby narrowing the search range and reducing the computational load for the inertial compensation value.

Step S107, on the basis of the inertial data, the robot uses epipolar constraint error values to screen first feature point pairs from feature points of the current frame image and feature points of all the reference frame images in the sliding window, which is equivalent to repeatedly executing step S102, so as to filter out feature point pairs with too large epipolar constraint error values, thereby filtering out unmatched feature points between the current frame image and each frame of reference frame image; and then, step S108 is executed.

Step S108, on the basis of the inertial data, the robot screens second feature point pairs from the first feature point pairs (screened in the newly executed step S107) by using depth values of the feature points, which is equivalent to repeatedly executing step S103; and a triangular geometric relationship matching the depth values of corresponding feature points is calculated by using displacement information and angle information of the robot (or camera) between the current frame image and a reference frame image, and normalized plane coordinates of feature points of each first feature point pair, which are involved in the inertial data; and the depth values of the feature points of the first feature point pair are calculated, and then a depth value of a feature point of the first feature point pair in the current frame image is compared with a depth value of a feature point of the first feature point pair in the reference frame image, so as to screen a second feature point pair. Then, step S109 is executed.

Step S109, the robot introduces a residual between the second feature point pair screened in the newly executed step S108, then calculates an inertial compensation value by combining the residual and a derivation result thereof with respect to the newly obtained inertial data (the inertial data corrected in newly executed step S105 or corrected in step S109 executed last time), and then corrects the newly obtained inertial data by using the inertial compensation value; and then the robot updates the inertial data in step S107 with the corrected inertial data, and correspondingly updates the feature points of the current frame image and the feature points of all the reference frame images in the sliding window in step S107 with the feature points included in the second feature point pairs screened in the newly executed step S108, which is equivalent to repeatedly executing step S105, but the screening for the third feature point pairs in step S104 is skipped from step S103, and step S105 is directly executed. Then step S106 is executed, in which it is judged whether both the number of executions of step S107 and the number of executions of step S108 reach the preset number of the iterative matchings, thereby repeatedly correcting the inertial data in step S109, reducing the residual, optimizing reference frame images subsequently filled in the sliding window, and improving the accuracy of robot localization.

It can be understood that, after step S102 and step S103 are executed, or each time after step S107 and step S108 are repeatedly executed (step S109 starts to be executed), the robot introduces a residual between the newly screened second feature point pair, and then calculates an inertial compensation value by combining the residual and a derivation result thereof with respect to the newly obtained inertial data, and then corrects the newly obtained inertial data by using the inertial compensation value; then the robot updates the inertial data with the corrected inertial data, and correspondingly updates the feature points of the current frame image and the feature points of all the reference frame images in the sliding window with the feature points included in the newly screened second feature point pairs, so as to narrow the search range of the feature points, thereby further saving a large amount of computational load of matching, and improving the localization and mapping speed of the robot.

It should be noted that, with regard to step S107, after the robot finishes executing step S105, when step S107 is executed for the first time, the robot calculates an epipolar constraint error value of each third feature point pair; wherein the epipolar constraint error value of each third feature point pair is decided by the inertial data corrected in step S105, and the specific epipolar constraint manner for the third feature point pair is the same as that in step S102; and the calculation manner for the epipolar constraint error value of the third feature point pair is the same as that in step S102, but the marking types and numbers of feature point pairs subjected to the epipolar constraint are different. When the epipolar constraint error value of one third feature point pair calculated by the robot is smaller than a preset pixel distance threshold, the first feature point pair is updated with the third feature point pair, and it is determined that except erroneously-matched reference frame images, a new first feature point pair is screened from the third feature point pairs screened in step S104.

It should be noted that, for step S107, when step S107 is repeatedly executed for an Nth time, the robot calculates an epipolar constraint error value of each second feature point pair screened in the newly executed step S108; wherein the epipolar constraint error value of each second feature point pair is determined from the inertial data corrected in step S109 executed last time; and when the epipolar constraint error value of the second feature point pair calculated by the robot is smaller than the preset pixel distance threshold, the second feature point pair is marked as the first feature point pair to update the first feature point pair, and it is determined that a new first feature point pair has been screened from all the second feature point pairs screened in step S13; wherein N is set to be greater than 1 and less than or equal to the preset number of the iterative matchings.

Step S110, on the basis of the number of feature points of the second feature point pairs in each frame of reference frame image, matched frame images are screened from the reference frame images in the sliding window; and then, step S111 is executed. Therefore, after choosing to complete iterative matching between each feature point in the current frame image and all feature points of each frame of reference frame image in the sliding window, the robot calculates the number of feature points of the second feature point pairs in each frame of reference frame image; and then on the basis of whether the number of second-second feature points calculated in each frame of reference frame satisfies a threshold condition, the robot screens a reference frame image matching the current frame image from the sliding window, so as to form one matched frame image pair by using the current frame image and a corresponding one frame of reference frame image; wherein a feature point of each second feature point pair in the current frame image is marked as a second-first feature point, and a feature point of the second feature point pair in the reference frame image is marked as a second-second feature point.

Specifically, the method in which on the basis of the number of feature points of the second feature point pairs in each frame of reference frame image, matched frame images are screened from the reference frame images in the sliding window, includes: after the number of repeated corrections of the inertial data reaches the preset number of the iterative matchings, the robot calculates, in each frame of reference frame image in the sliding window respectively, the number of feature points of the second feature point pairs in the frame of reference frame image, and takes said number as the number of matched second feature point pairs in the corresponding reference frame image; if feature points of the second feature point pairs in the reference frame image are marked as second-second feature points, then the number of matched second feature point pairs in the frame of reference frame image is equal to the number of second-second feature points in the frame of reference frame image; if the number of matched second feature point pairs in one frame of reference frame image is smaller than or equal to a second preset point number threshold, the robot determines that matching between the one frame of reference frame image and the current frame image fails, and can set the one frame of reference frame image as an erroneously-matched reference frame image; if the number of matched second feature point pairs in one frame of reference frame image is greater than the second preset point number threshold, the robot determines that the one frame of reference frame image successfully matches the current frame image, and sets the one frame of reference frame image as a matched frame image; and further, if the number of matched second feature point pairs in each frame of reference frame image is smaller than or equal to the second preset point number threshold, the robot determines that matchings between all frames of reference frame images in the sliding window and the current frame image fail, and then determines that tracking by the robot using the window-based matching mode fails. In some embodiments, the second preset point number threshold is set as 15, which is smaller than the first preset point number threshold. When the preset number of the iterative matchings is set to be increased, eliminated erroneously-matched point pairs in the sliding window become more or keep unchanged; therefore, the number of matched second feature point pairs in all the reference frame images becomes smaller or keeps unchanged, and the number of second-second feature points in each frame of reference frame image or the total number of second-second feature points in all frames of reference frame images becomes smaller or keeps unchanged.

Step S111, on the basis of epipolar constraint error values and the number of feature points of the second feature point pairs in each frame of matched frame image, an optimal matched frame image is selected from all the matched frame images, and it is determined that tracking by the robot using the window-based matching mode is successful; then, the robot removes the earliest filled reference frame images inside the sliding window to free up a memory space, and then fills the current frame image into the sliding window and update the current frame image as a new frame of reference frame image. In step S111, in all the screened matched frame images, the smaller a sum value of epipolar constraint errors corresponding to second-second feature points in a single frame of matched frame image is, the better the matching degree between the frame of matched frame image and the current frame image is, and the lower the matching error is; and in all the screened matched frame images, the larger the number of second-second feature points in a single frame of matched frame image is, the better the matching degree between the frame of matched frame image and the current frame image is, and the more the matching points are.

Therefore, in step S111, the method in which on the basis of the epipolar constraint error values and the number of feature points of the second feature point pairs in each frame of matched frame image, the optimal matched frame image is selected from all the matched frame images, specifically includes: in each frame of matched frame image, a sum value of epipolar constraint error values of second feature point pairs to which feature points in the frame of matched frame image belong is calculated as a cumulative epipolar constraint error value of the frame of matched frame image, such that one cumulative epipolar constraint error value is set for each frame of matched frame image; wherein the feature points of the second feature point pairs in the matched frame image are the second-second feature points, and the robot accumulates epipolar constraint error values of the second feature point pairs where all second-second feature points newly marked in one frame of matched frame image are located, to obtain a sum value of epipolar constraint error values of the second feature point pairs to which the feature points in the frame of matched frame image belong. In each frame of matched frame image, the number of feature points forming the second feature point pairs in the frame of matched frame image is calculated as the number of matched feature points in the frame of matched frame image, such that one feature point matching count is set for each frame of matched frame image; and when the feature points of the second feature point pairs in the matched frame image are the second-second feature points, the number of feature points forming the second feature point pairs in the frame of matched frame image is the number of second-second feature points existing in the frame of matched frame image. Then, the robot sets a matched frame image with a minimum cumulative epipolar constraint error value (for all frames of matched frame images) and the maximum number of matched feature points (for all frames of matched frame images) as an optimal matched frame image. In conclusion, the combination of step S102 to step S111 is the window-based matching mode, and the process in which the robot executes step S102 to step S111 is a process in which the robot performs image tracking using the window-based matching mode.

As some embodiments, for step S102 or step S107, the method of on the basis of the inertial data, by using the epipolar constraint error values, the first feature point pairs are screened from the feature points of the current frame image and the feature points of all the reference frame images in the sliding window, includes: the robot calculates an epipolar constraint error value of each feature point pair; when an epipolar constraint error value of one feature point pair calculated by the robot is greater than or equal to the preset pixel distance threshold, the feature point pair is marked as an erroneously-matched point pair, and then the corresponding one pair of feature points cannot be taken as matching objects in subsequent steps; wherein the robot sets the preset pixel distance threshold as a distance of a span of three pixel points, for example, a distance formed by three position-adjacent pixel points (one pixel point is the center, and the center and pixel points in left and right neighborhoods of the center form three adjacent pixel points), which can be equivalent to two pixel intervals formed by three pixel points in the same row or the same column. When an epipolar constraint error value of one feature point pair calculated by the robot is smaller than the preset pixel distance threshold, the feature point pair is marked as a first feature point pair and it is determined that a first feature point pair has been screened, and then the robot screens the first feature point pair from the feature points of the current frame image and the feature points of all the reference frame images in the sliding window. It should be noted that, the smaller an epipolar constraint error value of one feature point pair is, that is, the smaller an epipolar constraint error value, generated under epipolar constraint, of one feature point in the current frame image and one feature point in the reference frame image in the sliding window is, the smaller the matching error between this pair of feature points is.

In the present embodiment, each feature point pair is configured to be formed by one feature point (any feature point) of the current frame image and one feature point (any feature point) of the reference frame image, and cannot be formed by one pair of feature points in the same frame of reference frame image, feature points between different frames of reference frame images, or a pair of feature points in the current frame image; wherein each feature point of the current frame image and each feature point of each reference frame image in the sliding window form a feature point pair, such that brute-force matching is achieved between the current frame image and all the reference frame images in the sliding window. The robot may control to calculate an epipolar constraint error value of a corresponding feature point pair in sequence from normalized plane coordinates of each feature point of the current frame image and normalized plane coordinates of each feature point of each reference frame image in the sliding window, and then whenever the calculated epipolar constraint error value of one feature point pair is greater than or equal to the preset pixel distance threshold, the feature point pair is filtered out, and otherwise, the feature point pair is marked as a first feature point pair. After traversing all the feature point pairs, the robot screens all first feature point pairs from the feature points of the current frame image and the feature points of all the reference frame images in the sliding window, and completes matching between each feature point of the current frame and all the feature points of the reference frames, to obtain preliminarily filtered feature point pairs, and remove the interference of some feature point pairs that do not satisfy an error value.

It should be noted that, rigid motion of the camera is consistent with the motion of the robot, and two sequentially collected frame images have expression forms in two coordinate systems, including a coordinate system of the current frame with respect to the reference frame and a coordinate system of the reference frame with respect to the current frame image; and there is a certain geometric relationship between points in two frame images successively collected by the camera, and such a relationship may be described by epipolar geometry. The epipolar geometry describes a projective relationship (or the geometric relationship of various matching points) of various pixels in two frame images, and in some embodiments, the relationship is independent of an external scene, and is only related to internal parameters of the camera and photographing positions of the two images. In an ideal situation, the epipolar constraint error value equals to the numerical value 0, but the epipolar constraint error value is not necessarily the numerical value 0 due to the existence of noise, and the non-zero number may be used to measure the magnitude of the matching error between the feature points of the reference frame image and the feature points of the current frame image.

In some embodiments, R represents a rotation matrix from a C1 coordinate system to a C0 coordinate system, and may represent rotation from a kth frame image to a (k+1)th frame image; a vector C0-C1 is translation of an optical center C1 with respect to an optical center C0, and is denoted as T; and R and T can represent the motion of the robot between two frame images, are provided by the inertial sensor and can be included in the inertial data, and there are expression forms in two coordinate systems, including a coordinate system of the current frame with respect to the reference frame and a coordinate system of the reference frame with respect to the current frame. C0 and C1 are optical centers of the camera in two motion positions of the robot, i.e. pinholes in a pinhole camera model; Q is a three-dimensional point in a space, and Q0 and Q1 are pixel points corresponding to the point Q on different imaging planes respectively; and Q0 and Q1 are both two-dimensional points on the images, and in the present embodiment, they are both set as three-dimensional direction vectors for processing. Assuming a normalized image plane, on the plane, a focal length f=1; therefore, it can be defined that in a coordinate system with the optical center C0 as the origin, Q0 is located in a reference coordinate system with the optical center C0 as the origin, and Q1 is located in a reference coordinate system with the optical center C1 as the origin, and thus the coordinate system needs to be transformed. Herein, the coordinates of all points are transformed to the coordinate system with C0 as the origin. Because a direction vector is independent of a vector start position, only rotation needs to be considered for coordinate system transformation of Q0 and Q1. The normalized image plane herein is an epipolar plane composed of C0-C1-Q0-Q1.

As some embodiments, in step S102 or step S107, when the inertial data includes a translation vector of the current frame image relative to a reference frame image and a rotation matrix of the current frame image relative to the reference frame image, the robot marks the translation vector of the current frame image relative to the reference frame image as a first translation vector, and marks the rotation matrix of the current frame image relative to the reference frame image as a first rotation matrix; wherein the first translation vector represents a translation vector from a coordinate system of the current frame image to a coordinate system of the reference frame image, and the first rotation matrix represents a rotation matrix from the coordinate system of the current frame image to the coordinate system of the reference frame image, such that the inertial data chooses to represent displacement information and angle information in the coordinate system of the reference frame image. On this basis, the robot uses the first rotation matrix to transform normalized plane coordinates of one feature point (which can be expanded to any feature point) of the current frame image into the coordinate system of the reference frame image, so as to obtain first-first coordinates; wherein the normalized plane coordinates of the feature point are represented using a direction vector in the coordinate system of the current frame image; only the direction of the direction vector is considered, without considering the direction vector's start point or end point, and the direction vector forms a column vector, and has an inverse vector; then, transformation of the coordinate system of all the feature points of the current frame image only requires rotation, and the first-first coordinates can be represented by a direction vector in the coordinate system of the reference frame image. Therefore, in the present embodiment, a normalized vector of the feature point of the current frame image is set as a vector formed by the normalized plane coordinates of the feature point of the current frame image relative to the origin of the coordinate system of the current frame image; and a normalized vector of the feature point of the reference frame image is a vector formed by normalized plane coordinates of the feature point of the reference frame image relative to the origin of the coordinate system of the reference frame image. Then the robot controls the first rotation matrix to transform the normalized vector of the feature point of the current frame image to the coordinate system of the reference frame image, to obtain a first-first vector; then the robot controls to take a cross product between the first translation vector and the first-first vector, to obtain a first-second vector, wherein the first-second vector is perpendicular to both the first translation vector and the first-first vector; then the robot controls to take a dot product between a normalized vector of a feature point in a reference frame image in the sliding window and the first-second vector, and sets the dot product result (a cosine value indicating an included angle between the first-second vector and the normalized vector of the feature point in the reference frame image) as an epipolar constraint error value of the corresponding feature point pair. Specifically, the robot controls to sequentially take a dot product between a normalized vector of each feature point in each frame of reference frame image in the sliding window and the first-second vector, and then sets the result of each dot product as an epipolar constraint error value of the corresponding feature point pair.

It should be noted that, the normalized vector of the feature point of the current frame image is a vector formed by the normalized plane coordinates (the end point of the vector) of the feature point of the current frame image relative to the origin (the start point of the vector) of the coordinate system of the current frame image; and the normalized vector of the feature point of the reference frame image is a vector formed by the normalized plane coordinates (the end point of the vector) of the feature point of the reference frame image relative to the origin (the start point of the vector) of the coordinate system of the reference frame image.

As some embodiments, in step S102 or step S107, when the inertial data includes a translation vector of a reference frame image relative to the current frame image and a rotation matrix of the reference frame image relative to the current frame image, the robot marks the translation vector of the reference frame image relative to the current frame image as a second translation vector, and marks the rotation matrix of the reference frame image relative to the current frame image as a second rotation matrix; wherein the second translation vector represents a translation vector from the coordinate system of the reference frame image to the coordinate system of the current frame image, and the second rotation matrix represents a rotation matrix from the coordinate system of the reference frame image to the coordinate system of the current frame image, such that the inertial data chooses to represent displacement information and angle information in the coordinate system of the reference frame image. Then the robot controls the second rotation matrix to transform a normalized vector of a feature point of the reference frame image in the sliding window to the coordinate system of the current frame image, to obtain a second-first vector; then the robot controls to take a cross product between the second translation vector and the second-first vector, to obtain a second-second vector; wherein the second-second vector is perpendicular to both the second translation vector and the second-first vector; then the robot controls to take a dot product between the normalized vector of the feature point in the current frame image and the second-second vector, and sets the dot product result (a cosine value indicating an included angle between the second-second vector and the normalized vector of the feature point in the current frame image) as an epipolar constraint error value of the corresponding feature point pair. Specifically, the robot controls to sequentially take a dot product between the normalized vector of each feature point in the current frame image and the first-second vector, and then sets the result of each dot product as an epipolar constraint error value of the corresponding feature point pair. In this way, the epipolar constraint error value can describe, from a geometric dimension, feature point matching error information between image frames collected by the camera from different viewing angles.

As some embodiments, in step S103 or step S108, the method in which on the basis of the inertial data, the second feature point pairs are screened from the first feature point pairs by using the depth values of the feature points, includes: the robot calculates the ratio of a depth value of a feature point of each screened first feature point pair (which may be screened in step S102 or step S107) in the current frame image to a depth value of a feature point of the first feature point pair in a reference frame image; and if each first feature point pair is formed by a first feature point in the current frame image and a first feature point in the reference frame image, the ratio of a depth value of the first feature point in the current frame image to a depth value of a corresponding first feature point in the reference frame image is recorded, which is used for performing threshold comparison to filter out some first feature point pairs where first feature points having unmatched ratios are located. When the ratio of the depth value of the feature point of the first feature point pair in the current frame image to the depth value of the feature point of the first feature point pair in the reference frame image calculated by the robot is within a preset ratio threshold range, the robot marks the first feature point pair as a second feature point pair and determines that a second feature point pair has been screened; in some embodiments, the preset ratio threshold range is set to be greater than 0.5 and less than 1.5. When the ratio of the depth value of the feature point of the first feature point pair in the current frame image to the depth value of the feature point of the first feature point pair in the reference frame image calculated by the robot is not within the preset ratio threshold range, the robot marks the first feature point pair as an erroneously-matched point pair, thereby eliminating the erroneously-matched point pair from the first feature point pairs screened in step S102 and step S107, so as to perform filtering of the first feature point pairs, such that the search range of the feature point pairs can be narrowed during subsequent matching of the feature points.

As some embodiments, in step S103 or step S108, the method in which the robot calculates a depth value of a feature point, includes: when the inertial data includes a translation vector of the current frame image relative to a reference frame image and a rotation matrix of the current frame image relative to the reference frame image, the robot marks the translation vector of the current frame image relative to the reference frame image as a first translation vector, and marks the rotation matrix of the current frame image relative to the reference frame image as a first rotation matrix; wherein the first translation vector represents a translation vector from a coordinate system of the current frame image to a coordinate system of the reference frame image, and the first rotation matrix represents a rotation matrix from the coordinate system of the current frame image to the coordinate system of the reference frame image; then the robot controls the first rotation matrix to transform a normalized vector of a feature point of a first feature point pair in the current frame image to a coordinate system of the reference frame image, to obtain a first-first vector; then the robot controls to take a cross product between the normalized vector of the feature point of the first feature point pair in the current frame image and the first-first vector, to obtain a first-second vector; at the same time, the robot controls to take a cross product between the normalized vector of the feature point of the first feature point pair in the reference frame image and the first translation vector, and then performs negation on the cross product result, to obtain a first-third vector; wherein the cross product result of the normalized vector of the feature point of the first feature point pair in the reference frame image and the first translation vector is a vector perpendicular to both the normalized vector and the first translation vector, and an inverse vector of the vector is the first-third vector; then the robot sets the product between the first-third vector and an inverse vector of the first-second vector as the depth value of the feature point of the first feature point pair in the current frame image, and marks the depth value as a first depth value, which represents the distance between a three-dimensional point detected by the camera and an optical center (the origin of the coordinate system of the current frame image) when the camera collects the current frame image; then the robot marks a sum value of the first translation vector and the product between the first-first vector and the first depth value as a first-fourth vector, and then sets the product between the first-fourth vector and an inverse vector of the normalized vector of the feature point of the first feature point pair in the reference frame image as the depth value of the feature point of the first feature point pair in the reference frame image, which is equivalent to setting the product between the first-fourth vector and the inverse vector of the normalized vector as the depth value of the feature point in the reference frame image, and marking same as a second depth value, which indicates the distance between the same three-dimensional point and an optical center (the origin of the coordinate system of the reference frame image) when the camera collects the reference frame image. In this way, depth information of the pair of feature points is calculated in a triangularization manner on the basis of pose transformation information of the camera between the two frame images.

As some embodiments, in step S103 or step S108, the method in which the robot calculates a depth value of a feature point, includes: when the inertial data includes a translation vector of a reference frame image relative to the current frame image and a rotation matrix of the reference frame image relative to the current frame image, the robot marks the translation vector of the reference frame image relative to the current frame image as a second translation vector, and marks the rotation matrix of the reference frame image relative to the current frame image as a second rotation matrix; wherein the second translation vector represents a translation vector from the coordinate system of the reference frame image to the coordinate system of the current frame image, and the second rotation matrix represents a rotation matrix from the coordinate system of the reference frame image to the coordinate system of the current frame image, then the robot controls the second rotation matrix to transform a normalized vector of a feature point of a first feature point pair in the reference frame image to the coordinate system of the current frame image, to obtain a second-first vector; then the robot controls to take a cross product between a normalized vector of the feature point of the first feature point pair in the current frame image and the second-first vector, to obtain a second-second vector; at the same time, the robot controls to take a cross product between the normalized vector of the feature point of the first feature point pair in the current frame image and the second translation vector, and then performs negation on the cross product result, to obtain a second-third vector; then the robot sets the product between the second-third vector and an inverse vector of the second-second vector as the depth value of the feature point of the first feature point pair in the reference frame image, and marks the depth value as a second depth value, which represents the distance between a three-dimensional point detected by the camera and an optical center when the camera collects the reference frame image; then the robot marks a sum value of the second translation vector and the product between the second-first vector and the second depth value as a second-fourth vector, and then sets the product between the second-fourth vector and an inverse vector of the normalized vector of the feature point of the first feature point pair in the current frame image as the depth value of the feature point of the first feature point pair in the current frame image, and marks the depth value as a first depth value, which represents the distance between the same three-dimensional point and an optical center when the camera collects the current frame image.

In combination with step S103 or step S108, in the described embodiment of calculating the depth value, when the same point is projected onto two frames of images at different viewing angles, on the basis of a geometric relationship formed by projection points of the point in various frame images and corresponding optical centers, combining with depth information, a matching condition of feature points of two frame images in another scale information dimension is obtained, thereby improving the robustness and accuracy of feature point pair matching and image tracking, such that the robot localization is more reliable.

It should be noted that, the normalized vector of the feature point of the first feature point pair in the current frame image is a vector formed by normalized plane coordinates of the feature point of the first feature point pair in the current frame image relative to the origin of the coordinate system of the current frame image; and the normalized vector of the feature point of the first feature point pair in the reference frame image is a vector formed by normalized plane coordinates of the feature point of the first feature point pair in the reference frame image relative to the origin of the coordinate system of the reference frame image. In some embodiments, if the number of first feature point pairs screened in step S102 or step S107 is too large, a batch of first feature point pairs with a high matching degree needs to be acquired by using a least squares method, and then depth values of the feature points are solved; and since step S103 or step S108 relates to preliminary screening, the accuracy requirement is not high, and thus the use of the least squares method is not necessary.

In some embodiments, a feature point of a first feature point pair in the current frame image is marked as P1, an optical center when the camera collects the current frame image is marked as O1, a feature point of the first feature point pair in the reference frame image is marked as P2, and an optical center when the camera collects the reference frame image is marked as O2; O1-O2-P1-P2 constitute an epipolar plane, and an intersection line between the epipolar plane and the current frame image becomes an epipolar line of an imaging plane of the current frame image and passes through P1, and an intersection line of the epipolar plane and the reference frame image becomes an epipolar line of an imaging plane of the reference frame image and passes through P2. Then without considering noise effect of pixel points, a straight line O1P1 and a straight line O2P2 intersect at a point P3, and the length of a line segment O1P3 is a depth value of the feature point P1, and the length of a line segment O2P3 is a depth value of the feature point P2. When considering the noise effect range of the pixel points, an intersection point of the straight line O1P1 and the straight line O2P2 is a point P0, and the point P0 is not the point P3, and then position deviation between the point P0 and the point P3 can be used for measuring a matching error; therefore, the preset ratio threshold range needs to be set to compare the ratios of depth values between feature point pairs.

As some embodiments, in step S104, the method in which the third feature point pairs are screened from the second feature point pairs according to the similarities of the descriptors corresponding to the second feature point pairs, specifically includes: for the current frame image and a corresponding reference frame image in the sliding window, it may be considered that with regard to a second feature point pair marked between the current frame image and each frame of reference frame image in the sliding window, the robot calculates a similarity between a descriptor of a feature point of a second feature point pair in the reference frame image and a descriptor of a feature point of the second feature point pair in the current frame image, which may be understood as calculating a similarity between a descriptor of a feature point of each second feature point pair in the reference frame image and a descriptor of a feature point of the second feature point pair in the current frame image, and which is also equivalent to a similarity between a frame descriptor of each frame of reference frame image in the sliding window and a frame descriptor of the current frame image. Then, when a similarity between a descriptor of a feature point of the second feature point pair in a reference frame image and a descriptor of a feature point of the second feature point pair in the current frame image calculated by the robot is the minimum value among similarities between descriptors of the current frame image and descriptors of the reference frame image where the feature point of the second feature point pair is located, the second feature point pair is marked as a third feature point pair and it is determined that a third feature point pair has been screened; wherein the descriptors of the reference frame image where the feature point of the second feature point pair is located are descriptors of all feature points forming second feature point pairs in the reference frame image where the feature point of the second feature point pair is located, that is, there are a plurality of descriptors about the second feature point pairs in the same frame of reference frame image; and the descriptors of the current frame image are descriptors of feature points in the current frame image which form second feature point pairs with the feature points in the reference frame image where the feature point of the second feature point pair is located, that is, there are a plurality of descriptors about the second feature point pairs in the same current frame image. In some embodiments, the similarity between descriptors corresponding to each second feature point pair is represented by a Euclidean distance or a Hamming distance between a descriptor of a feature point in the current frame image and a descriptor of a feature point in a corresponding reference frame image in the sliding window. Thus, the similarity between descriptors of matching points can be calculated by using the sum of squares of Euclidean distances or Hamming distances in a plurality of dimensions, and then points with the minimum distance are taken as accurate points to be matched.

Specifically, in step S104, the robot denotes a feature point of each second feature point pair in the current frame image as a second-first feature point, and denotes a feature point of the second feature point pair in the reference frame image as a second-second feature point; and the robot needs to calculate the similarities between descriptors of all second-second feature points in the reference frame image and descriptors of second-first feature points corresponding thereto. Then, when the similarity between a descriptor of a feature point of the second feature point pair to be matched in a reference frame image and a descriptor of a feature point of the second feature point pair to be matched in the current frame image is the smallest value among similarities between descriptors of all second-second feature points in the reference frame image and descriptors of second-first feature points corresponding thereto, the second feature point pair is marked as a third feature point pair, and it is determined that a third feature point pair has been screened; wherein multiple third feature point pairs may be screened between each frame of reference frame image and the current frame image. The similarity between a descriptor of a feature point of the second feature point pair in a reference frame image and a descriptor of a feature point of the second feature point pair in the current frame image is similarity between a descriptor of a second-second feature point and a descriptor of a second-first feature point, and is taken as a similarity metric between two descriptors, and a specific calculation method thereof can be expressed as: the square root of the sum of squares of Euclidean distances or Hamming distances between the second-second feature points and the second-first feature points in a plurality of dimensions; wherein each dimension may represent a binary encoding form of the feature points.

As some embodiments, for step S105 or step S109, the robot marks a connecting line between an optical center when the camera collects the current frame image and a feature point of a preset feature point pair in the current frame image as a first observation line, and marks a connecting line between an optical center when the camera collects a reference frame image and a feature point of the same preset feature point pair in the reference frame image as a second observation line, and then marks an intersection point of the first observation line and the second observation line as a target detection point under an environmental condition without considering an error; wherein the optical center when the camera collects the current frame image, the optical center when the camera collects the reference frame image, and the target detection point are all located on the same plane, i.e. forming a state in which three points are coplanar, and then the same plane is set as the epipolar plane; or, the preset feature point pair, the optical center when the camera collects the current frame image, and the optical center when the camera collects the reference frame image are all located on the same plane, i.e. forming a state in which four points are coplanar. The robot marks an intersection line between the epipolar plane and the current frame image as an epipolar line in an imaging plane of the current frame image (which may be considered as in a coordinate system of the current frame image in some embodiments), and marks an intersection line between the epipolar plane and the reference frame image as an epipolar line in an imaging plane of the reference frame image (which may be considered as in a coordinate system of the reference frame image in some embodiments). Specifically, in the same preset feature point pair, after the feature point of the current frame image is transformed to the reference frame image, the feature point becomes a first projection point, and coordinates thereof are first-first coordinates; and the distance from the first projection point to the epipolar line in the imaging plane of the reference frame image (in the coordinate system of the reference frame image) is represented as a first residual value. It should be noted that, without considering pixel noise, the first projection point is located on the epipolar line in the imaging plane of the reference frame image (in the coordinate system of the current frame image), that is, after coordinate system transformation, a line segment from the current frame image actually observed from the viewing angle of the reference frame image can coincide with the epipolar line in the imaging plane of the reference frame image; in the same preset feature point pair, after the feature point of the reference frame image is transformed to the current frame image, the feature point becomes a second projection point, and coordinates thereof are second-first coordinate; and the distance from the second projection point to the epipolar line in the imaging plane of the current frame image is represented as a second residual value. The smaller the first residual value or the second residual value, the smaller the deviation of the corresponding projection point with respect to the epipolar line in the imaging plane to which the projection point is transformed, and the higher the matching degree of the corresponding preset feature point pair.

It should be noted that, in step S105, the preset feature point pair is the third feature point pair, and is a feature point pair screened in step S104; and in step S109, each time after step S107 and step S108 are repeatedly executed, the preset feature point pair is a second feature point pair screened in the newly executed step S108. The first feature point pairs, the second feature point pairs, and the third feature point pairs are each a pair of feature points formed by one feature point located in the current frame image and one feature point located in the reference frame image. A normalized vector of a feature point of the preset feature point pair in the current frame image is a vector formed by normalized plane coordinates of the feature point of the preset feature point pair in the current frame image relative to the origin of the coordinate system of the current frame image; and a normalized vector of a feature point of the preset feature point pair in the reference frame image is a vector formed by normalized plane coordinates of the feature point of the preset feature point pair in the reference frame image relative to the origin of the coordinate system of the reference frame image. The normalized plane coordinates may belong to coordinates in the epipolar plane, such that both coordinates of the feature point of the preset feature point pair in the current frame image and coordinates of the feature point of the preset feature point pair in the reference frame image are normalized to the epipolar plane for representation. Certainly, corresponding coordinate normalization processing may also be executed on the remaining types of feature point pairs.

As some embodiments, in step S105 or step S109, the method of introducing a residual into a pre-screened feature point pair specifically includes: when the inertial data includes a translation vector of the current frame image relative to a reference frame image and a rotation matrix of the current frame image relative to the reference frame image, the robot marks the translation vector of the current frame image relative to the reference frame image as a first translation vector, and marks the rotation matrix of the current frame image relative to the reference frame image as a first rotation matrix. In step S105, the preset feature point pair is the third feature point pair, and is a feature point pair screened in step S104; and in step S109, each time after step S107 and step S108 are repeatedly executed, the preset feature point pair is a second feature point pair screened in the newly executed step S108. The robot controls the first rotation matrix to transform the normalized vector of the feature point of the preset feature point pair in the current frame image to the coordinate system of the reference frame image, to obtain a first-first vector. In the present embodiment, the normalized vector of the feature point of the preset feature point pair in the current frame image is represented using a direction vector; only the direction of the direction vector is considered, without considering the direction vector's start point or end point, and the direction vector forms a column vector, and has an inverse vector; then, transformation of the coordinate system of all the feature points of the current frame image only requires rotation, and the first-first vector can be represented by a direction vector in the coordinate system of the reference frame image. The robot then controls to take a cross product between the first translation vector and the first-first vector, to obtain a first-second vector, and to form the epipolar line in the imaging plane of the reference frame image, wherein the first-second vector serves as a three-dimensional direction vector, and the pointing direction of the first-second vector is parallel to the epipolar line; and the epipolar line is an intersection line between the imaging plane of the reference frame image, and an epipolar plane which is constituted by one preset feature point pair, an optical center corresponding to the current frame image and an optical center corresponding to the reference frame image. Then, a square root is taken from a sum of squares of a horizontal-axis coordinate in the first-second vector and a vertical-axis coordinate in the first-second vector, to obtain the magnitude of the epipolar line, which may be considered as the length of the epipolar line in some embodiments; at the same time, the robot controls to take a dot product between the normalized vector of the feature point of the preset feature point pair in the reference frame image and the first-second vector, and then sets the dot product result as an epipolar constraint error value of the preset feature point pair; and then, the ratio of the epipolar constraint error value of the preset feature point pair to the magnitude of the epipolar line is set to a first residual value, and it is determined that a result numerical value of the residual has been introduced between the preset feature point pair.

On the basis of the embodiments above, the method in which a residual is introduced between the preset feature point pair, then an inertial compensation value is calculated by combining the residual and a derivation result thereof with respect to the inertial data, and then the inertial data is corrected by using the inertial compensation value, specifically includes: when the inertial data includes a translation vector of the current frame image relative to a reference frame image and a rotation matrix of the current frame image relative to the reference frame image, the robot marks an equation of multiplying the first rotation matrix and the normalized plane coordinates of the feature point of the preset feature point pair in the current frame image as a first-first transformation formula; then the robot marks an equation for taking a cross product between the first translation vector and the first-first transformation formula as a first-second transformation formula; then the robot marks an equation for taking a dot product between the normalized plane coordinates of the feature point of the preset feature point pair in the reference frame image and the first-second transformation formula as a first-third transformation formula; then the robot sets a calculation result of the first-second transformation formula as a numerical value 0 to constitute a linear equation, then takes a sum of squares of a coefficient of the linear equation in a horizontal-axis coordinate dimension and a coefficient of the linear equation in a vertical-axis coordinate dimension, and then calculates a square root from the obtained sum of squares, to obtain a first square root, which is equivalent to a projection length of a linear line represented by the linear equation in the imaging plane of the reference frame image in some embodiments; then, the robot sets an equation of multiplying the reciprocal of the first square root and the first-third transformation formula as a first-fourth transformation formula; then, the robot sets a calculation result of the first-fourth transformation formula as the first residual value, to form a first residual derivation formula, and determines that a residual has been introduced between the preset feature point pair; and then, the robot controls the first residual derivation formula to take partial derivatives of the first translation vector and the first rotation matrix, respectively, to obtain a Jacobian matrix, wherein the Jacobian matrix herein is a combination of a partial deviation result of the residual on the first translation vector and a partial deviation result of an error value on the first rotation matrix, so as to achieve the effect of correcting the change effect of the inertial data. Then, the product between an inverse matrix of the Jacobian matrix and the first residual value is set as the inertial compensation value, thereby constructing a least squares problem to find an optimal inertial compensation value; and in the present embodiment, the first residual derivation formula is equivalent to: a fitting function model of point-to-line deviation error values provided for fitting to the compensation value of the inertial data; wherein the residual therein belongs to error information, such as a sum of squares of minimum errors under the condition of the least squares method, such that the first residual derivation formula or the linear equation becomes an expression for solving the sum of squares of minimum errors; then, the first residual derivation formula is used to take partial derivative of two parameters, i.e. the first translation vector and the first rotation matrix, wherein the obtained formula may be organized as: the result of multiplying the Jacobian matrix by the fitted compensation value of the inertial data (inertial compensation value) is set to be equal to the first residual value, and then the robot sets the product between an inverse matrix of the Jacobian matrix and the first residual value as the inertia compensation value, thereby constructing a least squares problem to find the optimal inertial compensation value. Then, the robot corrects the inertial data using the inertial compensation value, and the specific correction includes addition, subtraction, multiplication and division operations on the original inertial data, which may be simple coefficient multiplication and division, and may also be multiplication of matrix vectors.

As some embodiments, in step S105 or step S109, the method of introducing a residual into a pre-screened feature point pair specifically includes: when the inertial data includes a translation vector of a reference frame image relative to the current frame image and a rotation matrix of the reference frame image relative to the current frame image, the robot marks the translation vector of the reference frame image relative to the current frame image as a second translation vector, and marks the rotation matrix of the reference frame image relative to the current frame image as a second rotation matrix; in step S105, the preset feature point pair is the third feature point pair, and is a feature point pair screened in step S104; and in step S109, each time after step S107 and step S108 are repeatedly executed, the preset feature point pair is a second feature point pair screened in the newly executed step S108. The robot controls the second rotation matrix to transform the normalized vector of the feature point of the preset feature point pair in the reference frame image to the coordinate system of the current frame image, to obtain a second-first vector; in the present embodiment, the normalized vector of the feature point of the preset feature point pair in the reference frame image is represented using a direction vector; only the direction of the direction vector is considered, without considering the direction vector's start point or end point, and the direction vector forms a column vector, and has an inverse vector; and then, transformation of the coordinate system of all the feature points of the current frame image only requires rotation, and the first-first vector can be represented by a direction vector in the coordinate system of the current frame image. Furthermore, the preset feature point pair is specific to step S105, and may also be updated to the second feature point pair in step S109. Then the robot controls to take a cross product between the second translation vector and the second-first vector, to obtain a second-second vector, and to form the epipolar line in the imaging plane of the current frame image, wherein the second-second vector serves as a three-dimensional direction vector, and the pointing direction of the second-second vector is parallel to the epipolar line; and the epipolar line is an intersection line between the imaging plane of the current frame image, and an epipolar plane which is constituted by one preset feature point pair, an optical center corresponding to the current frame image and an optical center corresponding to the reference frame image. Then a square root is taken from a sum of squares of a horizontal-axis coordinate in the second-second vector and a vertical-axis coordinate in the second-second vector, to obtain the magnitude of the epipolar line, which can be considered as a projection length of the straight line to which the second-second vector points in the imaging plane of the current frame image in some embodiments; at the same time, the robot controls to take a dot product between the normalized vector of the feature point of the preset feature point pair in the current frame image and the second-second vector, and then sets the dot product result as an epipolar constraint error value of the preset feature point pair; then, the ratio of the epipolar constraint error value of the preset feature point pair to the magnitude of the epipolar line is set to a second residual value, and it is determined that a result numerical value of the residual has been introduced between the preset feature point pair.

On the basis of the embodiments above, the method in which a residual is introduced between the preset feature point pair, then an inertial compensation value is calculated by combining the residual and a derivation result thereof with respect to the inertial data, and then the inertial data is corrected by using the inertial compensation value, specifically includes: when the inertial data includes a translation vector of a reference frame image relative to the current frame image and a rotation matrix of the reference frame image relative to the current frame image, the robot marks an equation of multiplying the second rotation matrix and the normalized plane coordinates of the feature point of the preset feature point pair in the reference frame image as a second-first transformation formula; then the robot marks an equation for taking a cross product between the second translation vector and the second-first transformation formula as a second-second transformation formula; then the robot marks an equation for taking a dot product between the normalized plane coordinates of the feature point of the preset feature point pair in the current frame image and the second-second transformation formula as a second-third transformation formula; then the robot sets a calculation result of the second-second transformation formula as a numerical value 0 to constitute a linear equation, then takes a sum of squares of a coefficient of the linear equation in a horizontal-axis coordinate dimension and a coefficient of the linear equation in a vertical-axis coordinate dimension, and then calculates a square root from the obtained sum of squares, to obtain a second square root, which is equivalent to a projection length of a linear line represented by the linear equation in the imaging plane of the current frame image in some embodiments; then, the robot sets an equation of multiplying the reciprocal of the second square root and the second-third transformation formula as a second-fourth transformation formula; then, the robot sets a calculation result of the second-fourth transformation formula as the second residual value, to form a second residual derivation formula, and determines that the residual has been introduced between the preset feature point pair; then, the robot controls the second residual derivation formula to take partial derivatives of the second translation vector and the second rotation matrix, respectively, to obtain a Jacobian matrix, wherein the Jacobian matrix herein is a combination of a partial deviation result of the residual on the second translation vector and a partial deviation result of an error value on the second rotation matrix, so as to achieve the effect of correcting the change effect of the inertial data. Then, the product between an inverse matrix of the Jacobian matrix and the second residual value is set as the inertial compensation value, thereby constructing a least squares problem to find an optimal inertial compensation value; and in the present embodiment, the second residual derivation formula is equivalent to: a fitting function model provided for fitting to the compensation value of the inertial data; wherein the residual therein belongs to error information, such as a sum of squares of minimum errors under the condition of the least squares method, such that the linear equation or the second residual derivation formula becomes an expression for solving the sum of squares of minimum errors; then, the second residual derivation formula is used to take partial derivative of two parameters, i.e. the second translation vector and the second rotation matrix, wherein the obtained formula may be organized as: the result of multiplying the Jacobian matrix by the fitted compensation value of the inertial data (inertial compensation value) is set to be equal to the second residual value, and then the robot sets the product between an inverse matrix of the Jacobian matrix and the second residual value as the inertial compensation value, thereby constructing a least squares problem to find an optimal inertial compensation value. Then, the robot corrects the inertial data using the inertial compensation value, and the specific correction includes addition, subtraction, multiplication and division operations on the original inertial data, which may be simple coefficient multiplication and division, and may also be multiplication of matrix vectors. Therefore, the original inertial data is subject to the test of iterative matching of visual feature point pairs to obtain partial derivative information that can be corrected, such that the inertial data is processed in an optimized manner, and the localization accuracy of the robot is improved.

As some embodiments, the method in which the robot performs image tracking using the projection-based matching mode, includes: step 21, the robot collects an image by the camera, and acquires inertial data by the inertial sensor; wherein images sequentially collected by the camera are a previous frame image and a current frame image, which are marked as two adjacent frame images. Then, step 22 is executed. After collecting each frame image, the camera acquires feature points from each frame image; wherein the feature points refer to environmental elements existing in the form of points in an environment where the robot is located, so as to facilitate matching with feature points of a previously collected image, thereby realizing tracking of the current frame image by the previous frame image. It should be noted that, an initial state quantity of a rotation matrix and an initial state quantity of a translation vector involved in a pose transformation relationship of the camera between two adjacent frames (two continuous frame images) are preset. On the basis of these initial state quantities, the robot performs integration processing depending on a displacement variation quantity sensed by the encoder disc between two frame images successively collected by the camera and an angle variation quantity sensed by the gyroscope between the two frame images successively collected by the camera, wherein the integration processing may be respectively performed on the displacement variation quantity and the angle variation quantity by using Euler integration, so as to obtain a pose transformation relationship and a pose variation quantity of the robot within a specified collection time interval, and then the latest rotation matrix and the latest translation vector may be obtained.

Step 22, the robot projects feature points of the previous frame image into the current frame image by using the inertial data, to obtain projection points; and then, step 23 is executed. The inertial data includes a rotation matrix of the previous frame image relative to the current frame image, and a translation vector of the previous frame image relative to the current frame image; and the robot controls the rotation matrix and the translation vector to transform the feature points in the previous frame image into a coordinate system of the current frame image, and then projects the feature points in the previous frame image to an imaging plane of the current frame image by internal parameters of the camera to obtain the projection points. In the process of controlling the rotation matrix and the translation vector to transform the feature points in the previous frame image into the coordinate system of the current frame image, it may be: rotation and translation operations are directly executed on coordinates of the feature points in the previous frame image, such that the coordinates of the feature points are transformed into the coordinate system of the current frame image; and it may also be: vectors of the feature points of the previous frame image with respect to the origin of a coordinate system of the previous frame image are first constructed, and denoted as vectors to be transformed; then the rotation matrix is controlled to multiply by the vectors to be transformed, to obtain rotated vectors; then, a point multiplication operation is performed on the used translation vector and the rotated vectors to obtain transformed vectors; and when the start points of the transformed vectors are the origin of the coordinate system of the current frame image, the end points of the transformed vectors are the projection points; wherein the feature points of the previous frame image may be normalized plane coordinates, but the vectors to be transformed, the rotated vectors, or the transformed vectors may be three-dimensional vectors. Thus, a pose transformation constraint relationship (epipolar geometric constraint) between the two frame images is formed.

Step 23, the robot searches for points to be matched in a preset search neighbourhood of each projection point respectively according to a standard distance between descriptors; wherein the points to be matched are feature points derived from the current frame image, and the points to be matched do not belong to the projection points; and then, the robot calculates a vector between the projection point and each found point to be matched, so as to determine the direction of the vector between the projection point and each found point to be matched in the preset search neighborhood to which the projection point belongs; furthermore, the robot marks a vector between one projection point participating in calculation in the preset search neighbourhood and one point to be matched as a vector to be matched, which is a vector pointing from the projection point to the point to be matched, wherein the direction pointing from the projection point to the point to be matched is the direction of the vector to be matched; and a method for calculating the vector to be matched is to subtract normalized plane coordinates of the projection point, obtained by projecting the previous frame image onto the current frame image, from normalized plane coordinates of the point to be matched in the current frame image, so as to generate the vector to be matched. In some embodiments, the projection point is a start point of the vector to be matched, and the point to be matched is an end point of the vector to be matched. In some embodiments, in the current frame image, a connecting line segment between the projection point and the point to be matched can be used to represent a norm of the vector to be matched, and a connecting line segment between the projection point and the point to be matched is marked as a line segment to be matched; the norm length of the vector is equal to the linear distance between the projection point and the point to be matched; and then, the robot executes step 24.

Specifically, the method in which the robot searches for points to be matched in a preset search neighbourhood of each projection point respectively according to the standard distance between descriptors, includes: the robot sets a circular neighbourhood by taking each projection point as a circle center point, and sets the circular neighbourhood as a preset search neighbourhood of the projection point, wherein the inertial data includes a pose variation quantity of the camera between the previous frame image and the current frame image, which may be equivalent to a pose variation quantity of the robot within a specified collection time interval, and the camera is fixedly equipped on the robot; the larger the pose variation quantity of the camera between the previous frame image and the current frame image is, the larger the radius of the preset search neighbourhood is set to be; and the smaller the pose variation quantity of the camera between the previous frame image and the current frame image is, the smaller the radius of the preset search neighbourhood is set to be, such that the matching range of the feature points is suitable for an actual collection range of the camera. One preset search neighbourhood is correspondingly set by taking each projection point as a circle center point. Then, in the preset search neighbourhood of each projection point, the robot starts to search from the circle center point of the preset search neighbourhood of the projection point, which is specifically searching in the preset search neighbourhood for feature points (which originally belong to the feature points of the current frame image) other than the projection point; and whenever a standard distance between a descriptor of a feature point in the current frame image found by the robot and a descriptor of the circle center point of the preset search neighbourhood is the closest, the found feature point in the current frame image is set as a point to be matched in the preset search neighbourhood, and set as a candidate matching point having a higher matching degree with the projection point in the current frame image; wherein the number of points to be matched in the preset search neighbourhood may be at least one, and may also be 0, and then when no point to be matched is found, the radius of the preset search neighbourhood needs to be expanded, so as to continue searching in a larger circle range.

It should be noted that, the standard distance is a Euclidean distance or a Hamming distance used under a standard matching condition between descriptors. The descriptor of one feature point is a binary description vector, and is composed of a plurality of 0 and 1. Here, 0 and 1 encode a magnitude relationship of two pixel brightness (for example, m and n) near the feature point, and if m is smaller than n, 1 is taken; otherwise, 0 is taken.

Step 231, the source of the descriptor specifically includes: a square neighbourhood taking one feature point as the center is selected, and the square neighbourhood is set as a descriptor area;

step 232, then the square neighbourhood can be denoised, and pixel point noise can be eliminated by using Gaussian kernel convolution, as the descriptor has strong randomness and is sensitive to noise.

Step 233, a point pair <m, n> is generated by a certain randomization algorithm, and if the brightness of the pixel point m is less than the brightness of the pixel point n, the point pair is encoded into a value 1, otherwise, the point pair is encoded into a value 0; and

Step 234, step 233 is repeatedly executed for several times (for example, 128 times) to obtain a 128-bit binary code, that is, the descriptor of the feature point.

In some embodiments, the method for selecting a feature point includes: a pixel point r is selected in an image, and it is assumed that the brightness thereof is Ir; then a threshold T0 (for example, 20% of Ir) is set; then, with the pixel point r as the center, 16 pixel points on a circle with a radius of 3 pixel points are selected. If the brightness of 9 continuous points on the selected circle is greater than (Ir+T0) or less than (Ir−T0), then the pixel point r may be considered as a feature point.

Step 24, the robot calculates the number of vectors to be matched which are parallel to each other, specifically in preset search neighborhoods of all projection points, and may also be in the current frame image or an imaging plane thereof, and as after all, the vectors to be matched are only marked in the preset search neighborhoods of the projection points at the beginning, and there is no counting interference factor in an area outside the preset search neighborhoods; and in all the vectors to be matched which are parallel to each other, the pointing directions (directions) of any two vectors to be matched are the same or opposite. It should be noted that, between the previous frame image and the current frame image, if one projection point and one point to be matched normally match, then the direction of the projection point pointing to the vector to be matched of the point to be matched is parallel to one fixed preset mapping direction, and then the vectors to be matched corresponding to all normally matched feature point pairs are parallel to each other; wherein the preset mapping direction is associated with the inertial data, in particular an angular feature in which the rotation matrix decides the pointing direction of the preset mapping direction. Then, step 25 is executed.

Step 25, it is judged whether the number of vectors to be matched which are parallel to each other is greater than or equal to a preset matching number, if so, step 26 is executed; otherwise, step 27 is executed. The number of vectors to be matched which are parallel to each other is a statistical result of the robot in preset search neighborhoods of all projection points or in the current frame image.

Step 26, it is determined that the robot succeeds in performing tracking using the projection-based matching mode, and it is determined that the robot succeeds in tracking the current frame image. Specifically, when the number of vectors to be matched which are parallel to each other is greater than or equal to the preset matching number, all vectors to be matched which are parallel to each other are set as target matching vectors, which is equivalent to setting at least two vectors to be matched with the same direction and at least two vectors to be matched with opposite directions as target matching vectors; and correspondingly, all line segments to be matched which are parallel to or coincide with each other are set as target matching line segments, and the start point and the end point of each target matching vector are set as a pair of target matching points, and correspondingly, two end points of the target matching line segment are set as a pair of target matching points, which both belong to feature points. Then, the start point of a vector to be matched that is not parallel to the target matching vector and the end point of the vector to be matched are set as a pair of erroneously-matched points, and correspondingly, line segments to be matched that are not parallel to the target matching line segments and do not overlap with the target matching line segments are set as erroneously-matched line segments, and two end points of each erroneously-matched line segment are set as a pair of erroneously-matched points. In this way, matching of feature points is completed once within the preset search neighbourhood of each projection point set in step S23, so as to obtain points to be matched having the closest standard distance with respect to descriptors of the projection points, and each pair of erroneously-matched points is filtered out within the preset search neighbourhood.

Step 27, the robot calculates that the number of vectors to be matched which are parallel to each other in preset search neighborhoods of all projection points (or in the current frame image) is less than the preset matching number, then it is judged whether the number of repeated executions of step 23 reaches a preset expansion times, and if so, the coverage of the preset search neighborhood of each projection point stops from being enlarged, and it is determined that the robot fails to perform tracking using the projection-based matching mode;

otherwise, the coverage of the preset search neighbourhood of each projection point is expanded to obtain an expanded preset search neighbourhood, and the preset search neighbourhood as described in step 23 is updated with the expanded preset search neighbourhood; and then step 23 is executed. In some embodiments, the preset matching number is set as 15, and the preset expansion number is set as 2; in some embodiments, the number of points to be matched in the preset search neighbourhood may be at least one, and may also be 0, and then when no point to be matched is found, the radius of the preset search neighbourhood needs to be expanded, then the process returns to step 23, so as to continue searching in a larger circle range. The preset expansion number is associated with the size of the current frame image and a preset expansion step length; and if it is calculated, in the current frame image, that the number of vectors to be matched which are parallel to each other is less than the preset matching number, the preset expansion step length needs to be set to expand the coverage of the preset search neighbourhood of each projection point. However, due to the constraint of the size of the current frame image, the preset search neighbourhood of each projection point can only perform reasonable coverage expansion within a limited number of times, such that the same projection point matches more reasonable (having the closest standard distance between descriptors) points to be matched.

Each time after step 23 is executed, step 24 is executed, and in step 24, consistency of vector directions is used to remove erroneously-matched points, that is, each erroneously-matched vector in the preset search neighbourhood is filtered out, and then it is unnecessary to calculate the erroneously-matched vector when step 23 is executed repeatedly, thereby greatly reducing the computational load. Until after the number of repeated executions of step 23 by the robot reaches the preset expansion number, if it is still calculated that the number of vectors to be matched which are parallel to each other in the current frame image is still less than the preset matching number, the coverage of the preset search neighbourhood of each projection point stops from being expanded, and it is determined that the robot fails to perform tracking using the projection-based matching mode.

In conclusion, the combination of step 22 to step 27 is the projection-based matching mode, in which in combination with the pose variation quantity of the robot and the projection transformation relationship of feature points between two adjacent frame images, vectors to be matched with consistent directions are identified in the current frame image to be tracked and the number of the vectors to be matched is calculated, and it is determined whether the robot successfully completes image tracking using the projection-based matching mode; and thus the erroneous matching rate of features is reduced, the calculation difficulty is reduced, and the window-based matching mode can also be switched into after tracking fails, thereby further reducing the search range of feature point matching, and improving the accuracy and efficiency of robot vision localization. In addition, in the present disclosure, only a single camera is used for localization, and the device is simple and the cost is low.

The content above only relates to preferred embodiments of the present disclosure. It should be noted that for a person of ordinary skill in the art, several improvements and modifications can also be made without departing from the principle of the present disclosure, and these improvements and modifications shall also be considered as within the scope of protection of the present disclosure.

What is claimed is:

1. A visual tracking method of robot, wherein an execution body of the visual tracking method of robot is a robot fixedly equipped with a camera and an inertial sensor;
the visual tracking method of robot comprises:
performing image tracking, by the robot, using a window-based matching mode, and when the robot succeeds in performing tracking using the window-based matching mode, stopping performing image tracking, by the robot, using the window-based matching mode, and then performing image tracking, by the robot, using a projection-based matching mode; and
then, when the robot fails to perform tracking using the projection-based matching mode, stopping performing image tracking, by the robot, using the projection-based matching mode, and then performing image tracking, by the robot, using the window-based matching mode.

2. The visual tracking method of the robot according to claim 1, wherein visual tracking method of the robot further comprises: when the robot fails to perform tracking using the window-based matching mode, stopping performing image tracking, by the robot, using the window-based matching mode, and then clearing, by the robot, a sliding window, and then performing image tracking using the window-based matching mode;
wherein the image tracking is used to indicate matching between feature points of a previously collected image and feature points of a current frame image; and
wherein after the robot succeeds in performing tracking using the window-based matching mode, the current frame image is filled in the sliding window, so as to facilitate tracking of an image collected by the robot in real time; and
in a process of performing image tracking, by the robot, using the projection-based matching mode, in a case that it is detected that a time interval between the current frame image and a previous frame image exceeds a preset time threshold, stopping performing image tracking, by the robot, using the projection-based matching mode, and instead, performing image tracking using the window-based matching mode;
wherein the feature points are pixel points belonging to the image, and the feature points are environmental elements existing in the form of points in an environment where the camera is located.

3. The visual tracking method of the robot according to claim 2, wherein performing image tracking, by the robot, using the window-based matching mode comprises:
step S11, collecting, by the robot, the current frame image by the camera, and acquiring inertial data by the inertial sensor;
step S12, on the basis of the inertial data, by using epipolar constraint error values, screening first feature point pairs from the feature points of the current frame image and feature points of all reference frame images in the sliding window; wherein the sliding window is configured to fill in at least one pre-collected frame image; and the feature points are pixel points of the image, and the feature points are environmental elements existing in the form of points in an environment where the camera is located;
step S13, on the basis of the inertial data, screening second feature point pairs from the first feature point pairs by using depth values of the feature points;
step S14, screening third feature point pairs from the second feature point pairs according to similarities of descriptors corresponding to the second feature point pairs;
step S15, introducing a residual between each third feature point pair, then calculating an inertial compensation value by combining the residual and a derivation result thereof with respect to the inertial data, and then correcting the inertial data by using the inertial compensation value; then updating the inertial data in the step S12 with the corrected inertial data, updating the feature points of the current frame image in the step S12 with feature points of the third feature point pairs in the current frame image in the step S14, and updating the feature points of all the reference frame images in the sliding window in the step S12 with feature points of the third feature point pairs in the reference frame images in the step S14;
step S16, repeatedly executing the step S12 and the step S13 until the number of repeated executions reaches a preset number of iterative matchings, and then on the basis of the number of feature points of the second feature point pairs in each frame of reference frame image, screening matched frame images from the reference frame images in the sliding window; wherein each time after the step S12 and the step S13 are repeatedly executed, introducing, by the robot, a residual between the second feature point pairs screened in a newly executed the step S13, then calculating an inertial compensation value by combining the residual and a derivation result thereof with respect to the newly obtained inertial data, and then correcting the newly obtained inertial data by using the inertial compensation value; and then updating the inertial data in the step S12 with the corrected inertial data, and correspondingly updating the feature points of the current frame image and the feature points of all the reference frame images in the sliding window in the step S12 with the feature points included in the second feature point pairs screened in the newly executed the step S13; and
step S17, on the basis of the epipolar constraint error values and the number of feature points of the second feature point pairs in each frame of matched frame image, selecting an optimal matched frame image from all the matched frame images, and determining that tracking by the robot using the window-based matching mode is successful;
wherein a combination of the step S12, the step S13, the step S14, the step S15, the step S16 and the step S17 is the window-based matching mode.

4. The visual tracking method of the robot according to claim 3, wherein in the step S12, on the basis of the inertial data, by using the epipolar constraint error values, screening the first feature point pairs from the feature points of the current frame image and the feature points of all the reference frame images in the sliding window, comprises:
calculating, by the robot, an epipolar constraint error value of each feature point pair; when the epipolar constraint error value of a feature point pair is greater than or equal to a preset pixel distance threshold, marking the feature point pair as an erroneously-matched point pair; and when the epipolar constraint error value of a feature point pair is smaller than the preset pixel distance threshold, marking the feature point pair as a first feature point pair and determining that a first feature point pair has been screened;
wherein the each feature point pair is configured to be formed by one feature point of the current frame image and one feature point of a reference frame image, and each feature point of the current frame image and each feature point of each reference frame images in the sliding window form a feature point pair.

5. The visual tracking method of the robot according to claim 4, wherein in the step S12, when the inertial data comprises a translation vector of the current frame image relative to the reference frame image and a rotation matrix of the current frame image relative to the reference frame image, marking, by the robot, the translation vector of the current frame image relative to the reference frame image as a first translation vector, and marking the rotation matrix of the current frame image relative to the reference frame image as a first rotation matrix; then controlling, by the robot, the first rotation matrix to transform a normalized vector of a feature point of the current frame image to a coordinate system of the reference frame image, to obtain a first-first vector; then controlling to take a cross product between the first translation vector and the first-first vector, to obtain a first-second vector; and then controlling to take a dot product between a normalized vector of a feature point in the reference frame image in the sliding window and the first-second vector, and then setting the dot product result as an epipolar constraint error value of a corresponding feature point pair;
or in the step S12, when the inertial data comprises a translation vector of a reference frame image relative to the current frame image and a rotation matrix of the reference frame image relative to the current frame image, marking, by the robot, the translation vector of the reference frame image relative to the current frame image as a second translation vector, and marking the rotation matrix of the reference frame image relative to the current frame image as a second rotation matrix; then, controlling, by the robot, the second rotation matrix to transform a normalized plane vector of a feature point of the reference frame image in the sliding window to a coordinate system of the current frame image, to obtain a second-first vector; then controlling to take a cross product between the second translation vector and the second-first vector, to obtain a second-second vector; and then controlling to take a dot product between a normalized vector of a feature point in the reference frame image in the sliding window and the first-second vector, and then setting the dot product result as an epipolar constraint error value of a corresponding feature point pair;
wherein the normalized vector of the feature point of the current frame image is a vector formed by normalized plane coordinates of the feature point of the current frame image relative to the origin of the coordinate system of the current frame image; and a normalized vector of the feature point of the reference frame image is a vector formed by normalized plane coordinates of the feature point of the reference frame image relative to the origin of the coordinate system of the reference frame image.

6. The visual tracking method of the robot according to claim 3, wherein in the step S13, on the basis of the inertial data, screening the second feature point pairs from the first feature point pairs by using the depth values of the feature points, comprises:
regarding each of the first feature point pairs screened in the step S12, calculating, by the robot, a ratio of a depth value of a feature point of a first feature point pair in the current frame image to a depth value of a feature point of the first feature point pair in a reference frame image;
when the ratio of the depth value of the feature point of the first feature point pair in the current frame image to the depth value of the feature point of the first feature point pair in the reference frame image is within a preset ratio threshold range, marking the first feature point pair as a second feature point pair and determining that the second feature point pair has been screened; and
when the ratio of the depth value of the feature point of the first feature point pair in the current frame image to the depth value of the feature point of the first feature point pair in the reference frame image is not within the preset ratio threshold range, marking the first feature point pair as an erroneously-matched point pair.

7. The visual tracking method of the robot according to claim 6, wherein in the step S13, when the inertial data comprises a translation vector of the current frame image relative to a reference frame image and a rotation matrix of the current frame image relative to the reference frame image, marking, by the robot, the translation vector of the current frame image relative to the reference frame image as a first translation vector, and marking the rotation matrix of the current frame image relative to the reference frame image as a first rotation matrix; then controlling, by the robot, the first rotation matrix to transform a normalized vector of a feature point of the first feature point pair in the current frame image to a coordinate system of the reference frame image, to obtain a first-first vector; then controlling to take a cross product between the normalized vector of the feature point of the first feature point pair in the current frame image and the first-first vector, to obtain a first-second vector; at the same time, controlling to take a cross product between the normalized vector of the feature point of the first feature point pair in the reference frame image and the first translation vector, and then performing negation on the cross product result, to obtain a first-third vector; then setting the product between the first-third vector and an inverse vector of the first-second vector as the depth value of the feature point of the first feature point pair in the current frame image, and marking the depth value as a first depth value, which represents the distance between a three-dimensional point detected by the camera and an optical center when the camera collects the current frame image; then marking a sum value of the first translation vector and the product between the first-first vector and the first depth value as a first-fourth vector, and then setting the product between the first-fourth vector and an inverse vector of the normalized vector of the feature point of the first feature point pair in the reference frame image as the depth value of the feature point of the first feature point pair in the reference frame image, and marking the depth value as a second depth value, which represents the distance between the same three-dimensional point and an optical center when the camera collects the current frame image;
or in the step S13, when the inertial data comprises a translation vector of a reference frame image relative to the current frame image and a rotation matrix of the reference frame image relative to the current frame image, marking, by the robot, the translation vector of the reference frame image relative to the current frame image as a second translation vector, and marking the rotation matrix of the reference frame image relative to the current frame image as a second rotation matrix; then controlling, by the robot, the second rotation matrix to transform a normalized vector of a feature point of the first feature point pair in the reference frame image to a coordinate system of the current frame image, to obtain a second-first vector; then controlling to take a cross product between a normalized vector of the feature point of the first feature point pair in the current frame image and the second-first vector, to obtain a second-second vector; at the same time, controlling to take a cross product between the normalized vector of the feature point of the first feature point pair in the current frame image and the second translation vector, and then performing negation on the cross product result, to obtain a second-third vector; then setting the product between the second-third vector and an inverse vector of the second-second vector as the depth value of the feature point of the first feature point pair in the reference frame image, and marking the depth value as a second depth value, which represents the distance between a three-dimensional point detected by the camera and an optical center when the camera collects the reference frame image; then marking a sum value of the second translation vector and the product between the second-first vector and the second depth value as a second-fourth vector, and then setting the product between the second-fourth vector and an inverse vector of the normalized vector of the feature point of the first feature point pair in the current frame image as the depth value of the feature point of the first feature point pair in the current frame image, and marking the depth value as a first depth value, which represents the distance between the same three-dimensional point and an optical center when the camera collects the current frame image;
wherein the normalized vector of the feature point of the first feature point pair in the current frame image is a vector formed by normalized plane coordinates of the feature point of the first feature point pair in the current frame image relative to the origin of the coordinate system of the current frame image; and the normalized vector of the feature point of the first feature point pair in the reference frame image is a vector formed by normalized plane coordinates of the feature point of the first feature point pair in the reference frame image relative to the origin of the coordinate system of the reference frame image.

8. The visual tracking method of the robot according to claim 3, wherein in the step S14, screening the third feature point pairs from the second feature point pairs according to the similarities of the descriptors corresponding to the second feature point pairs, comprises:
for the current frame image and each frame of reference frame image in the sliding window, calculating, by the robot, a similarity between a descriptor of a feature point of each of the second feature point pairs in the reference frame image and a descriptor of a feature point of a second feature point pair in the current frame image; and
when a similarity between a descriptor of a feature point of the second feature point pair in a reference frame image and a descriptor of a feature point of the second feature point pair in the current frame image is the minimum value among similarities between descriptors of the current frame image and descriptors of the reference frame image where the feature point of the second feature point pair is located, marking the second feature point pair as a third feature point pair and determining that a third feature point pair has been screened;
wherein the descriptors of the reference frame image where the feature point of the second feature point pair is located are descriptors of all feature points forming second feature point pairs in the reference frame image where the feature point of the second feature point pair is located; and the descriptors of the current frame image are descriptors of feature points in the current frame image which form the second feature point pair with the feature points in the reference frame image where the feature point of the second feature point pair is located; and
wherein the similarity between descriptors corresponding to the each second feature point pair is represented by a Euclidean distance or a Hamming distance between a descriptor of a feature point in the current frame image and a descriptor of a feature point in a corresponding reference frame image in the sliding window.

9. The visual tracking method of the robot according to claim 8, wherein the step S14 further comprises: each time after the robot has found all feature points forming the second feature point pairs between the current frame image and one frame of reference frame image in the sliding window, in a case that the robot calculates that the number of third feature point pairs in the frame of reference frame image is smaller than or equal to a first preset point number threshold, determining that matching between the current frame image and the frame of reference frame image fails, and setting the frame of reference frame image as an erroneously-matched reference frame image; and in a case that the robot calculates that the number of third feature point pairs in the frame of reference frame image is greater than the first preset point number threshold, determining that the current frame image successfully matches the frame of reference frame image;
wherein when the robot determines that all matchings between the current frame image and all frames of reference frame images in the sliding window fail, it is determined that tracking by the robot using the window-based matching mode fails, and then the robot clears the images in the sliding window.

10. The visual tracking method of the robot according to claim 3, wherein marking, by the robot, a connecting line between an optical center when the camera collects the current frame image and a feature point of a preset feature point pair in the current frame image as a first observation line, and marking a connecting line between an optical center when the camera collects a reference frame image and a feature point of the same preset feature point pair in the reference frame image as a second observation line, and then marking an intersection point of the first observation line and the second observation line as a target detection point;
wherein the preset feature point pair, the optical center when the camera collects the current frame image, and the optical center when the camera collects the reference frame image are all located on the same plane; or the optical center when the camera collects the current frame image, the optical center when the camera collects the reference frame image, and the target detection point are all located on the same plane; and the same plane is an epipolar plane; and
denoting, by the robot, an intersection line between the epipolar plane and the current frame image as an epipolar line in an imaging plane of the current frame image, and denoting an intersection line between the epipolar plane and the reference frame image as an epipolar line in an imaging plane of the reference frame image;
in the same preset feature point pair, after the feature point of the current frame image is transformed to the reference frame image, the feature point becomes a first projection point, and coordinates thereof are first-first coordinates; the distance from the first projection point to the epipolar line in the imaging plane of the reference frame image is represented as a first residual value; in the same preset feature point pair, after the feature point of the reference frame image is transformed to the current frame image, the feature point becomes a second projection point, and coordinates thereof are second-first coordinate; and the distance from the second projection point to the epipolar line in the imaging plane of the current frame image is represented as a second residual value;
in the step S15, the preset feature point pair is a third feature point pair; and
in the step S16, each time after the step S12 and the step S13 are repeatedly executed, the preset feature point pair is a second feature point pair screened in the newly executed step S13.

11. The visual tracking method of the robot according to claim 10, wherein in the step S15 or the step S16, the method of introducing the residual comprises:
when the inertial data comprises a translation vector of the current frame image relative to a reference frame image and a rotation matrix of the current frame image relative to the reference frame image, marking, by the robot, the translation vector of the current frame image relative to the reference frame image as a first translation vector, and marking the rotation matrix of the current frame image relative to the reference frame image as a first rotation matrix; controlling, by the robot, the first rotation matrix to transform a normalized vector of the feature point of the preset feature point pair in the current frame image to a coordinate system of the reference frame image, to obtain a first-first vector; then controlling to take a cross product between the first translation vector and the first-first vector, to obtain a first-second vector, and forming the epipolar line in the imaging plane of the reference frame image; then taking a square root from a sum of squares of a horizontal-axis coordinate in the first-second vector and a vertical-axis coordinate in the first-second vector, to obtain the magnitude of the epipolar line; at the same time, controlling to take a dot product between a normalized vector of the feature point of the preset feature point pair in the reference frame image and the first-second vector, and then setting the dot product result as an epipolar constraint error value of the preset feature point pair; then, setting the ratio of the epipolar constraint error value of the preset feature point pair to the magnitude of the epipolar line as a first residual value;
or when the inertial data comprises a translation vector of a reference frame image relative to the current frame image and a rotation matrix of the reference frame image relative to the current frame image, marking, by the robot, the translation vector of the reference frame image relative to the current frame image as a second translation vector, and marking the rotation matrix of the reference frame image relative to the current frame image as a second rotation matrix; then controlling, by the robot, the second rotation matrix to transform a normalized vector of the feature point of the preset feature point pair in the reference frame image to a coordinate system of the current frame image, to obtain a second-first vector; then controlling to take a cross product between the second translation vector and the second-first vector, to obtain a second-second vector, and forming the epipolar line in the imaging plane of the current frame image; then taking a square root from a sum of squares of a horizontal-axis coordinate in the second-second vector and a vertical-axis coordinate in the second-second vector, to obtain the magnitude of the epipolar line; at the same time, controlling to take a dot product between a normalized vector of the feature point of the preset feature point pair in the current frame image and the second-second vector, and then setting the dot product result as an epipolar constraint error value of the preset feature point pair; then, setting the ratio of the epipolar constraint error value of the preset feature point pair to the magnitude of the epipolar line as a second residual value;
wherein the normalized vector of the feature point of the preset feature point pair in the current frame image is a vector formed by normalized plane coordinates of the feature point of the preset feature point pair in the current frame image relative to the origin of the coordinate system of the current frame image; and the normalized vector of the feature point of the preset feature point pair in the reference frame image is a vector formed by normalized plane coordinates of the feature point of the preset feature point pair in the reference frame image relative to the origin of the coordinate system of the reference frame image.

12. The visual tracking method of the robot according to claim 11, wherein in the step S15 or the step S16, the method of introducing a residual between the preset feature point pair, then calculating an inertial compensation value by combining the residual and a derivation result thereof with respect to the newly obtained inertial data, and then correcting the newly obtained inertial data by using the inertial compensation value, comprises:
when the inertial data comprises a translation vector of the current frame image relative to a reference frame image and a rotation matrix of the current frame image relative to the reference frame image, the robot marks an equation of multiplying the first rotation matrix and the normalized plane coordinates of the feature point of the preset feature point pair in the current frame image as a first-first transformation formula; then marking an equation for taking a cross product between the first translation vector and the first-first transformation formula as a first-second transformation formula; then marking an equation for taking a dot product between the normalized vector of the feature point of the preset feature point pair in the reference frame image and the first-second transformation formula as a first-third transformation formula; then setting a calculation result of the first-second transformation formula as a numerical value 0 to constitute a linear equation, then taking a sum of squares of a coefficient of the linear equation in a horizontal-axis coordinate dimension and a coefficient of the linear equation in a vertical-axis coordinate dimension, and then calculating a square root from the obtained sum of squares, to obtain a first square root, and then, setting an equation of multiplying the reciprocal of the first square root and the first-third transformation formula as a first-fourth transformation formula; then, setting a calculation result of the first-fourth transformation formula as the first residual value, to form a first residual derivation formula, and determining that the residual has been introduced between the preset feature point pair; then, controlling the first residual derivation formula to take partial derivatives of the first translation vector and the first rotation matrix, respectively, to obtain a Jacobian matrix; then setting the product between an inverse matrix of the Jacobian matrix and the first residual value as an inertia compensation value; and then correcting, by the robot, the inertial data by using the inertial compensation value;
or when the inertial data comprises the translation vector of the reference frame image relative to the current frame image and the rotation matrix of the reference frame image relative to the current frame image, marking, by the robot, an equation of multiplying the second rotation matrix and the normalized vector of the feature point of the preset feature point pair in the reference frame image as a second-first transformation formula; then marking an equation for taking a cross product between the second translation vector and the second-first transformation formula as a second-second transformation formula; then marking an equation for taking a dot product between the normalized vector of the feature point of the preset feature point pair in the current frame image and the second-second transformation formula as a second-third transformation formula; then setting a calculation result of the second-second transformation formula as a numerical value 0 to constitute a linear equation, then taking a sum of squares of a coefficient of the linear equation in a horizontal-axis coordinate dimension and a coefficient of the linear equation in a vertical-axis coordinate dimension, and then calculating a square root from the obtained sum of squares, to obtain a second square root, and then, setting an equation of multiplying the reciprocal of the second square root and the second-third transformation formula as a second-fourth transformation formula; then, setting a calculation result of the second-fourth transformation formula as the second residual value, to form a second residual derivation formula, and determining that the residual has been introduced between the preset feature point pair; then, controlling the second residual derivation formula to take partial derivatives of the second translation vector and the second rotation matrix, respectively, to obtain a Jacobian matrix; then setting the product between an inverse matrix of the Jacobian matrix and the second residual value as an inertia compensation value; and then correcting, by the robot, the inertial data by using the inertial compensation value.

13. The visual tracking method of the robot according to claim 9, wherein with regard to the step S16, after the robot finishes executing the step S15, when the step S12 is repeatedly executed for the first time, calculating, by the robot, an epipolar constraint error value of each third feature point pair except the erroneously-matched reference frame image; wherein the epipolar constraint error value of each third feature point pair is decided by the inertial data corrected in the step S15; when the epipolar constraint error value of a third feature point pair is smaller than a preset pixel distance threshold, updating a first feature point pair with the third feature point pair, and determining that a new first feature point pair has been screened from the third feature point pairs;
when the step S12 is repeatedly executed for an Nth time, calculating, by the robot, an epipolar constraint error value of each of the second feature point pairs screened in the newly executed step S13; and when the epipolar constraint error value of a second feature point pair is smaller than the preset pixel distance threshold, updating a first feature point pair with the second feature point pair, and determining that a new first feature point pair has been screened from all the second feature point pairs screened in the step S13; wherein N is set to be greater than 1 and less than or equal to the preset number of the iterative matchings.

14. The visual tracking method of the robot according to claim 6, wherein in the step S16, on the basis of the number of feature points of the second feature point pairs in each frame of reference frame image, screening matched frame images from the reference frame images in the sliding window, comprises:
in each frame of reference frame image in the sliding window, respectively calculating, by the robot, the number of feature points of the second feature point pairs in the frame of reference frame image;
in a case that the number of matched second feature point pairs in one frame of reference frame image is less than or equal to a second preset point number threshold, determining that matching between the one frame of reference frame image and the current frame image fails; in a case that the number of matched second feature point pairs in one frame of reference frame image is greater than the second preset point number threshold, determining, by the robot, that the one frame of reference frame image successfully matches the current frame image, and setting the one frame of reference frame image as a matched frame image; and in a case that the number of matched second feature point pairs in each frame of reference frame image is smaller than or equal to the second preset point number threshold, determining, by the robot, that matchings between all frames of reference frame images in the sliding window and the current frame image fail, and then determining that tracking by the robot using the window-based matching mode fails.

15. The visual tracking method of the robot according to claim 5, wherein in the step S17, on the basis of the epipolar constraint error values and the number of feature points of the second feature point pairs in each frame of matched frame image, selecting the optimal matched frame image from all the matched frame images, comprises:
in each frame of matched frame image, calculating a sum value of epipolar constraint error values of second feature point pairs to which feature points in the frame of matched frame image belong as a cumulative epipolar constraint error value of the frame of matched frame image;
in each frame of matched frame image, calculating the number of feature points forming the second feature point pairs in the frame of matched frame image as the number of matched feature points in the frame of matched frame image; and
then, setting a matched frame image with a minimum cumulative epipolar constraint error value and a maximum number of matched feature points as an optimal matched frame image.

16. The visual tracking method of the robot according to claim 2, wherein performing image tracking, by the robot, using the projection-based matching mode, comprises:
step S21, collecting, by the robot, images by the camera, and acquiring inertial data by the inertial sensor; wherein the images collected by the camera comprises the previous frame image and the current frame image;
step S22, projecting, by the robot, feature points of the previous frame image into the current frame image by using the inertial data, to obtain projection points, wherein the inertial data comprises a rotation matrix of the previous frame image relative to the current frame image and a translation vector of the previous frame image relative to the current frame image;
step S23, searching for, by the robot, points to be matched in a preset search neighbourhood of each projection point respectively according to a standard distance between descriptors; then, calculating, by the robot, a vector between a projection point and each found point to be matched, and marking a vector pointing from the projection point to the found point to be matched as a vector to be matched; wherein the points to be matched are feature points derived from the current frame image, and the points to be matched do not belong to the projection points; and each vector to be matched corresponds to one projection point and one point to be matched; and
step S24, calculating, by the robot, the number of vectors to be matched which are parallel to each other, and when it is calculated that the number of vectors to be matched which are parallel to each other is greater than or equal to a preset matching number, determining that the robot succeeds in performing tracking using the projection-based matching mode, and determining that the robot succeeds in tracking the current frame image.

17. The visual tracking method of the robot according to claim 16, wherein setting, by the robot, each of the vectors to be matched which are parallel to each other as a target matching vector, and marking vectors to be matched which are not parallel to the target matching vector as erroneously-matched vectors in preset search neighborhoods of all projection points, and then, setting one projection point corresponding to each erroneously-matched vector and one point to be matched corresponding to the erroneously-matched vector as a pair of erroneously-matched points, and setting one projection point corresponding to the target matching vector and one point to be matched corresponding to the target matching vector as a pair of target matching points;
wherein the directions of all the vectors to be matched which are parallel to each other are the same or opposite, the target matching vector is kept parallel to a preset mapping direction, and the preset mapping direction is associated with the inertial data.

18. The visual tracking method of the robot according to claim 16, wherein the step S24 further comprises: when it is calculated that the number of the vectors to be matched which are parallel to each other is less than the preset matching number, expanding, by the robot, a coverage of the preset search neighbourhood of the each projection point according to a preset expansion step length, to obtain an expanded preset search neighbourhood, and updating the preset search neighbourhood in the step S23 with the expanded preset search neighbourhood; and then executing the step S23 until the number of repeated executions of the step S23 by the robot reaches a preset expansion times, and then stopping expanding the coverage of the preset search neighborhood of the each projection point, and determining that the robot fails to perform tracking using the projection-based matching mode;
wherein a combination of the step S22, the step S23 and the step S24 is the projection-based matching mode.

19. The visual tracking method of the robot according to claim 16, wherein searching for, by the robot, the points to be matched in the preset search neighbourhood of the each projection point respectively according to the standard distance between descriptors, comprises:
setting, by the robot, a circular neighbourhood by taking the each projection point as a circle center point, and setting the circular neighbourhood as a preset search neighbourhood of the projection point, wherein the inertial data comprises a pose variation quantity of the camera between the previous frame image and the current frame image; the larger the pose variation quantity of the camera between the previous frame image and the current frame image is, the larger the radius of the preset search neighbourhood is set to be; and the smaller the pose variation quantity of the camera between the previous frame image and the current frame image is, the smaller the radius of the preset search neighbourhood is set to be; and
in the preset search neighbourhood of teach projection point, starting to search, by the robot, from the circle center point of the preset search neighbourhood of the projection point, for feature points other than the projection point; and when a standard distance between a descriptor of a found feature point in the current frame image and a descriptor of the circle center point of the preset search neighbourhood is the closest, setting the found feature point in the current frame image as a point to be matched in the preset search neighbourhood;
wherein the standard distance is represented using a Euclidean distance or a Hamming distance.
